(19) United States
(12) Patent Application Publication
(10) Pub. No.: US 2024/0063997 A1
(43) Pub. Date: Feb. 22, 2024

(54) PHASE COMPENSATING DEVICE, OPTICAL RECEIVER, AND PHASE COMPENSATING METHOD

(71) Applicant: Fujitsu Limited, Kawasaki-shi (JP)

(72) Inventors: Yoshitaka NOMURA, Shinagawa (JP); Hisao NAKASHIMA, Kawasaki (JP); Nobukazu KOIZUMI, Kawasaki (JP)

(73) Assignee: Fujitsu Limited, Kawasaki-shi (JP)

(21) Appl. No.: 18/341,302

(22) Filed: Jun. 26, 2023

(30) Foreign Application Priority Data
Aug. 12, 2022 (JP) 2022-129126

(51) Int. Cl. H04L 7/00; H04B 10/60

(52) U.S. Cl. CPC H04L 7/0075; H04B 10/60

(57) ABSTRACT

A phase compensation device configured to compensate phase of a received signal obtained by photoelectrically converting a phase-modulated optical signal, the phase compensation device includes a processor configured to: detect whether reversal of a phase of the received signal is present, based on a known signal contained in the received signal; compensate the phase of the received signal, based on whether reversal of the phase is detected; and after compensating the phase, compensate reversal of the phase of the received signal, based on whether reversal of the phase is detected.

### CROSS REFERENCE TO RELATED APPLICATIONS

This application is based upon and claims the benefit of priority of the prior Japanese Patent Application No. 2022-129126, filed on Aug. 12, 2022, the entire contents of which are incorporated herein by reference.

### FIELD OF THE INVENTION

The embodiments discussed herein relate to a phase compensating device, an optical receiver, and a phase compensating method.

### BACKGROUND OF THE INVENTION

An optical transmitter of an optical transmission system includes a modulator that converts an analog electrical signal into an optical signal. The modulator may induce sign inversion, signal distortion, etc., during the conversion. Although an automatic bias controller (ABC) included in the modulator acts to control the bias voltage at a Null point so as to minimize the signal distortion, the phase signal is output for transmission without being regulated.

For example, by setting different Null points on I and Q axes of IQ modulation, the modulator outputs an optical signal whose phase is reversed between I axis and Q axis, in response to an in-phase input signal. The IQ phase-reversed optical signal generated by the modulator is transmitted from the optical transmitter via a transmission path to an optical receiver. Without being corrected by a 90-degree hybrid, a transimpedance amplifier (TIA), or the like also in the optical receiver, the optical signal is transmitted to a reception digital signal processor (DSP) that processes the received signal. Accordingly, to demodulate the optical signal correctly, the DSP needs to perform signal processing for detecting and compensating the IQ phase reversal. The optical receiver restores the same IQ constellation as that of the transmitting side by detecting phase fluctuation of the optical signal and compensating the phase.

An example of a prior art is an N^{th}-power method-based phase compensation technique (see, for example, Japanese Laid-Open Patent Publication No. 2017-041666) of deciding whether IQ phase reversal has occurred, by comparing the signal pattern of a differentially processed transmission signal with the signal pattern of a differentially processed, demodulated signal after hard decision. Another example is a technique (see, for example, International Publication No. WO2014/126132) of compensating phase by calculating a phase variation error signal, based on plural pilot symbols inserted on the transmitting side and predefined reference symbols, to estimate phase variation between the pilot symbols by a filter processing. Yet another example is a technique (see, for example, International Publication No. WO2013/084366) of defining a corresponding relationship between modulated light phase and information by detecting phase reversal state of a Mach-Zehnder modulator in the optical transmitter. Still another example is a demodulating device technique (see, for example, Japanese Laid-Open Patent Publication No. 2008-278173) of performing demodulation by interchanging input signal channels, based on correlation values between a symbol sequence of an IQ channel input signal and a known symbol sequence. Still yet another example is a technique (see, for example, Japanese Laid-Open Patent Publication No. 2014-014111) of compensating phase by transmitting from the transmitting side, a signal containing sync signals and known codes arranged at predefined locations and checking on the reception side the known signals sandwiched between the sync signals, to detect a cycle slip. A further example is a technique (see, for example, Japanese Laid-Open Patent Publication No. 2011-228819) of compensating frequency offset by calculating on the reception side, a spectrum centroid of a digital signal and regulating frequency offset that is estimated based on the spectrum centroid to be smaller.

### SUMMARY OF THE INVENTION

According to an aspect of an embodiment, a phase compensation device is configured to compensate phase of a received signal obtained by photoelectrically converting a phase-modulated optical signal, the phase compensation device includes: a memory; and a processor coupled to the memory, the processor configured to: detect whether reversal of a phase of the received signal is present, based on a known signal contained in the received signal; compensate the phase of the received signal, based on whether reversal of the phase is detected; and after compensating the phase, compensate reversal of the phase of the received signal, based on whether reversal of the phase is detected.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram of an example of a phase compensation device according to an embodiment.

FIG. 2A is a diagram depicting plural phase reversal states of a received signal corresponding to a transmission signal.

FIG. 2B is a table depicting plural phase reversal states of a received signal corresponding to the transmission signal.

FIG. 3A is a diagram depicting a configuration example of an optical transmission/reception system according to the embodiment.

FIG. 3B is a diagram depicting a configuration example of the optical transmission/reception system according to the embodiment.

FIG. 4A is an explanatory view of a modulator of an optical transmitter.

FIG. 4B is an explanatory view of the modulator of the optical transmitter.

FIG. 4C is an explanatory view of the modulator of the optical transmitter.

FIG. 5A is an explanatory view of a conventional phase compensation device based on an n-th power method.

FIG. 5B is an explanatory view of the conventional phase compensation device based on the n-th power method.

FIG. 5C depicts an IQ constellation with phase fluctuation.

FIG. 6A is an explanatory view of an example of frequency offset detection based on the conventional fourth-power method.

FIG. 6B is an explanatory view of an example of frequency offset detection based on the conventional fourth-power method.

FIG. 7A is an explanatory view of an example of frequency offset detection based on the conventional fourth-power method.

FIG. 7B is an explanatory view of an example of frequency offset detection based on the conventional fourth-power method.

FIG. 8A is an explanatory view of phase compensation using a known signal.

FIG. 8B is an explanatory view of phase compensation using a known signal.

FIG. 9A depicts an example of conventional frequency offset detection using a known signal under conditions where frequency offset is +π/4 without phase reversal by a modulator.

FIG. 9B depicts an example of conventional frequency offset detection using a known signal under conditions where the frequency offset is +π/4 without phase reversal by the modulator.

FIG. 10A depicts an example of conventional frequency offset detection using a known signal under conditions where the frequency offset is +π/8 without phase reversal by the modulator.

FIG. 10B depicts an example of conventional frequency offset detection using a known signal under conditions where the frequency offset is +π/8 without phase reversal by the modulator.

FIG. 11A depicts an example of conventional frequency offset detection using a known signal under conditions where the frequency offset is +π/4 with phase reversal (I axis reversal) by the modulator.

FIG. 11B depicts an example of conventional frequency offset detection using a known signal under conditions where the frequency offset is +π/4 with phase reversal by the modulator.

FIG. 12A depicts an example of conventional frequency offset detection using a known signal under conditions where the frequency offset is +π/8 with phase reversal (I axis reversal) by the modulator.

FIG. 12B depicts an example of conventional frequency offset detection using a known signal under conditions where the frequency offset is +π/8 with phase reversal by the modulator.

FIG. 13A is an explanatory view of insertion of a known signal into a transmission signal.

FIG. 13B is an explanatory view of insertion of a known signal into a transmission signal.

FIG. 14 is a view depicting a configuration example of a phase reversal detecting unit.

FIG. 15 is a flowchart depicting an example of phase reversal detection processing by the phase reversal detecting unit.

FIG. 16A is an explanatory view of an example of phase reversal detection by the phase reversal detecting unit.

FIG. 16B is an explanatory view of an example of phase reversal detection by the phase reversal detecting unit.

FIG. 16C is an explanatory view of an example of phase reversal detection by the phase reversal detecting unit.

FIG. 17 is an explanatory view of an example of phase reversal detection effected by the phase reversal detecting unit.

FIG. 18 is a diagram depicting an operation example of a phase compensation device in a case of no occurrence of phase reversal.

FIG. 19 is a view depicting operation of an optical frequency offset compensating unit in operation example 1.

FIG. 20 is a diagram depicting operation of a phase noise compensating unit in operation example 1.

FIG. 21 is a table for explaining action of the phase reversal compensating unit in operation example 1.

FIG. 22 is a diagram depicting an operation example of the phase compensation device in a case where I axis and Q axis phase reversals have occurred.

FIG. 23 is a view depicting action of the optical frequency offset compensating unit in operation example 2.

FIG. 24 is a diagram depicting operation of the phase noise compensating unit in operation example 2.

FIG. 25 is a table for explaining operation of the phase reversal compensating unit in operation example 2.

FIG. 26 is a diagram depicting operation example of the phase compensation device in a case where only I axis phase reversal has occurred.

FIG. 27 is a view depicting operation of the optical frequency offset compensating unit in operation example 3.

FIG. 28 is a diagram depicting operation of the phase noise compensating unit in operation example 3.

FIG. 29 is a table for explaining operation of the phase reversal compensating unit in operation example 3.

FIG. 30 is a diagram depicting operation example of the phase compensation device in a case where only Q axis phase reversal has occurred.

FIG. 31 is a view depicting action of the optical frequency offset compensating unit in operation example 4.

FIG. 32 is a diagram depicting operation of the phase noise compensating unit in operation example 4.

FIG. 33 is a table for explaining operation of the phase reversal compensating unit in operation example 4.

### DESCRIPTION OF THE INVENTION

Embodiments of a phase compensation device, an optical receiver, and a phase compensation method of the disclosure are described in detail with reference to the drawings. The phase compensation device is disposed in the optical receiver. When receiving an optical signal (transmission signal) transmitted through a transmission line from an optical transmitter, the phase compensation device of the embodiment detects whether the transmission signal undergoes phase reversal at a signal point (symbol point) on an IQ constellation, at a stage upstream to (before) phase compensation. The phase compensation device performs phase compensation of a received signal using a known signal contained in the transmission signal, to demodulate the received signal.

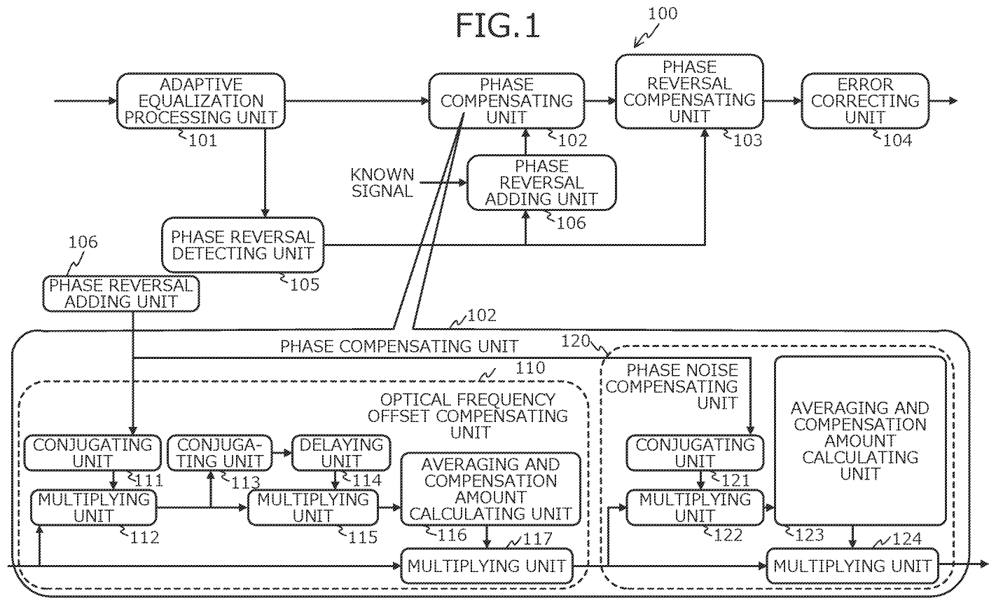

FIG. 1 is a configuration diagram of an example of the phase compensation device according to the embodiment. An overview of the phase compensation device according to the embodiment is first given. A phase compensation device 100 depicted in FIG. 1 may be functionally implemented by, for example, a DSP or a field programmable gate array (FPGA). For the input IQ received signal, the phase compensation device 100 allows connection to an adaptive equalization processing unit 101, a phase compensating unit 102, a phase reversal compensating unit 103, an error correcting unit 104 in sequence.

The adaptive equalization processing unit 101 receives, from, e.g., a TIA of the optical receiver, a received digital signal obtained by A/D converting an analog signal having an amplitude component and a phase component, and performs adaptive equalization processing. The phase compensating unit 102 performs phase compensation for the received signal using the known signal. The phase reversal compensating unit 103 performs phase reversal processing for the received signal. The error correcting unit 104 performs error correction of the received signal.

The phase compensation device 100 of the embodiment includes a phase reversal detecting unit 105 that detects phase reversal of the received signal by an output branch from the adaptive equalization processing unit 101. The result of the phase reversal detection by the phase reversal detecting unit 105 is output to the phase reversal compensating unit 103 and a phase reversal adding unit 106. As depicted in FIG. 1, in the phase compensation device 100 of the embodiment, the phase reversal detecting unit 105 is arranged at a stage upstream to the phase compensating unit 102.

The phase compensation device 100 of the embodiment performs phase compensation using the known signal. As is described later, for example, the known signal includes a pilot signal PS inserted into transmitting data at a certain interval, e.g., at a K symbol interval by the optical transmitter.

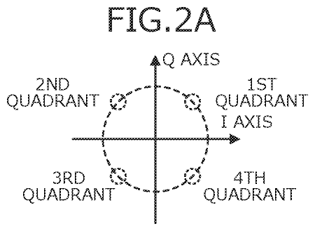

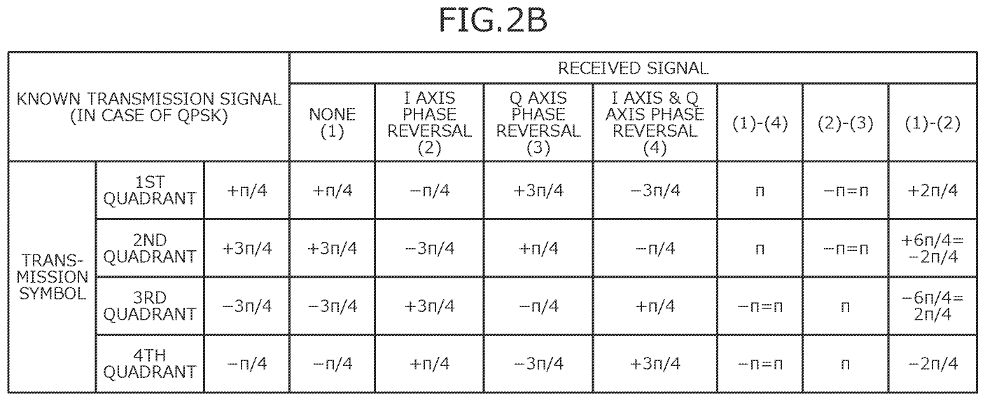

The phase reversal adding unit 106 depicted in FIG. 1 determines the state of phase reversal detected by the phase reversal detecting unit 105 and outputs phase reversal results according to the phase-reversal-state, to the phase compensating unit 102. This phase reversal adding unit 106 outputs to the phase compensating unit 102, two different phase reversal results for four different phase reversal states that are described in FIG. 2 hereinafter. For example, in cases where phase reversal occurs for only I axis or only Q axis, the phase reversal adding unit 106 regards it as an occurrence of only I axis reversal and outputs to the phase compensating unit 102, a result that phase reversal has occurred.

FIG. 1 depicts, in a lower portion thereof, an internal configuration example of the phase compensating unit 102. The phase compensation device 100 of the embodiment performs phase compensation that uses the known signal as a reference for phase reversal detection. The phase compensating unit 102 includes an optical frequency offset compensating unit 110 arranged at a stage upstream and a phase noise compensating unit 120 arranged at a subsequent stage downstream.

By employing a configuration where the phase reversal detecting unit 105 is arranged at an upstream stage relative to the phase compensating unit 102, the internal configuration of the phase compensating unit 102 of the embodiment may be a general configuration. By arranging the phase reversal detecting unit 105 at an upstream stage relative to the phase compensating unit 102, the phase compensating unit 102 need not have a conventional n-th power, e.g., fourth-power computing unit, enabling use of a multiplying unit for simpler computation, which results in reduction in computation amount and power consumption.

The optical frequency offset compensating unit 110 includes a conjugating unit (first conjugating unit) 111, a multiplying unit (first multiplying unit) 112, a conjugating unit (second conjugating unit) 113, a delaying unit 114, and a multiplying unit (second multiplying unit) 115. The optical frequency offset compensating unit 110 includes an averaging and compensation amount calculating unit (first averaging and compensation amount calculating unit) 116 and a multiplying unit (third multiplying unit) 117.

The conjugating unit 111 performs conjugate computation of an output of the phase reversal adding unit 106. The multiplying unit 112 multiplies together a branch signal of the received signal and a known signal output from the conjugating unit 111. The conjugating unit 111 performs conjugate computation of an output of the multiplying unit 112. The delaying unit 114 delays an output of the conjugating unit 113 by a predetermined amount (e.g., by one symbol). The multiplying unit 115 multiplies an output of the multiplying unit 112 and an output of the delaying unit 114 together. The averaging and compensation amount calculating unit 116 performs averaging for an output of the multiplying unit 115, to calculate a required phase compensation amount. The multiplying unit 117 outputs an output obtained by multiplying the received signal by the compensation amount, to the phase noise compensating unit 120 that is downstream.

The phase noise compensating unit 120 includes a conjugating unit 121, a multiplying unit (fourth multiplying unit) 122, an averaging and compensation amount calculating unit (second averaging and compensation amount calculating unit) 123, and a multiplying unit (fifth multiplying unit) 124.

The conjugating unit 121 performs conjugate computation of an output of the phase reversal adding unit 106. The multiplying unit 122 multiplies together an output of the optical frequency offset compensating unit 110 and a known signal output from the conjugating unit 121. The averaging and compensation amount calculating unit 123 performs averaging for an output of the multiplying unit 122, to calculate a required phase compensation amount. The multiplying unit 124 multiplies a received signal by the compensation amount.

IQ phase reversal is detected using a difference (Δαₜ) between a phase difference for two symbols obtained from the received signal and a phase difference (expected phase difference between PSs of two symbols) caused by demodulation of the transmission signal at the optical transmitter side. The phase compensating unit 102 works correctly even when the phases of all data of the received signal are shifted equally by a certain amount (π). Thus, phase reversal processing for the received signal in the phase compensating unit 102 may be carried out in two different ways as described hereinafter. As described above, the phase reversal of the received signal occurs at a modulator of the optical transmitter and is transmitted to the optical receiver.

FIGS. 2A and 2B are a diagram and a table depicting plural phase reversal states of a received signal corresponding to a transmission signal.

A. With regard to the received signal, a relationship with the phase shifted by π is established in (1) a case without phase reversal or (4) a case of occurrence of both I axis and Q axis phase reversals, so that the phase compensating unit 102 works correctly even in a case of processing as being a case without phase reversal.

B. With regard to the received signal, a relationship with the phase shifted by π is established in (2) a case of occurrence of only I axis phase reversal or (3) a case of occurrence of only Q axis phase reversal, so that the phase compensating unit 102 works correctly even in a case of processing as being a case of occurrence of only I axis phase reversal. In a case of occurrence of only I axis phase reversal (or Q axis phase reversal) by the modulator, a relationship with the phase shifted equally by a certain amount is not established for all data, as compared with (1) the case without phase reversal and thus, the phase compensating unit 102 does not operate correctly.

For this reason, the phase reversal detecting unit 105 determines whether the received signal is in a first state of A. ((1) without phase reversal or (4) occurrence of both I axis and Z-axis phase reversals) or in a second state of B. ((2) occurrence of only I axis phase reversal for the received signal or (3) occurrence of only Q axis phase reversal for the received signal).

The phase reversal detecting unit 105 determines the first state of A. as without phase reversal and determines the second state of B. as undergoing phase reversal. In case of the state of B, the phase reversal adding unit 106 adds phase reversal to the input signal and outputs it, assuming that only I axis reversal has occurred, irrespective of whether the phase reversal is only I axis reversal or only Q axis reversal. The phase reversal compensating unit 103 performs phase reversal compensation, assuming that only I axis reversal has occurred, irrespective of whether the phase reversal is only I axis reversal or only Q axis reversal.

Details of operation examples of phase compensation of the phase compensating unit 102 in the phase reversal states (1) to (4) are described later.

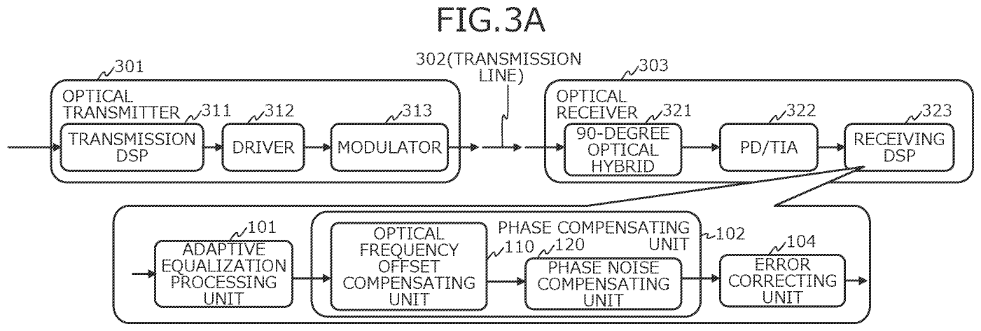

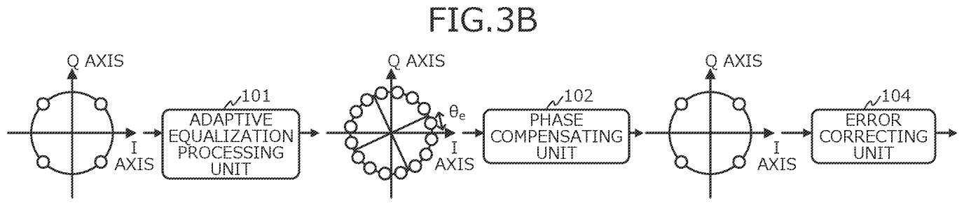

FIGS. 3A and 3B are diagrams depicting a configuration example of an optical transmission/reception system according to the embodiment. The optical transmission/reception system depicted in FIG. 3A includes an optical transmitter 301 that transmits coherent light, a transmission line 302, and an optical receiver 303.

The optical transmitter 301 includes a transmitting DSP 311, a driver 312, a modulator 313, etc. The optical transmitter 301 converts transmitting data input to the transmitting DSP 311 into, e.g., transmitting data of QPSK and outputs it via the driver 312 to the modulator 313. The modulator 313 converts the transmitting data into an optical signal and optically outputs the optical signal to the transmission line 302 of an optical fiber or the like. QPSK is an abbreviation for quadrature phase shift keying.

The optical receiver 303 includes a 90-degree optical hybrid 321, a photoelectric converting unit 322 such as PD/TIA, a receiving DSP 323, etc. The optical receiver 303 performs polarization separation by the 90-degree optical hybrid 321 to extract an electric field of received signal by IQ and photoelectrically converts the received signal by the photoelectric converting unit 322 to extract an amplitude component and a phase component. The receiving DSP 323 has the functions of the phase compensation device 100 described in FIG. 1 to subject the received signal to waveform shaping and phase compensation, for output to the exterior.

The 90-degree optical hybrid 321 extracts a received signal, based on a local oscillation light source (local light source) within the optical receiver 303. The optical frequency offset compensating unit 110 compensates a difference (frequency offset) between a frequency f of an optical signal transmitted from the optical transmitter 301 and a frequency f′ of an optical signal received by the optical receiver 303. The phase noise compensating unit 120 cancels the phase difference of transmission and reception optical signals, to reproduce and output carrier waves of the optical signals. A function of the phase compensating unit 102 that compensates the phase difference of the received optical signals is implemented by the optical frequency offset compensating unit 110 and the phase noise compensating unit 120 in the receiving DSP 323.

FIG. 3B depicts phase fluctuation. For example, the optical transmitter 301 of 4-phase QPSK transmits a symbol as an optical signal at a constant symbol cycle so that signal points are arranged in first to fourth quadrants of I and Q axes (constellation). However, due to a difference in laser frequency between the optical transmitter 301 and the optical receiver 303, phase noise, etc., a carrier wave phase fluctuation θe occurs in the received signal output of the adaptive equalization processing unit 101 on the optical receiver 303 side. The phase compensating unit 102 detects and compensates this carrier wave phase fluctuation θe to thereby restore the same constellation as that of the optical signal transmitted from the optical transmitter 301.

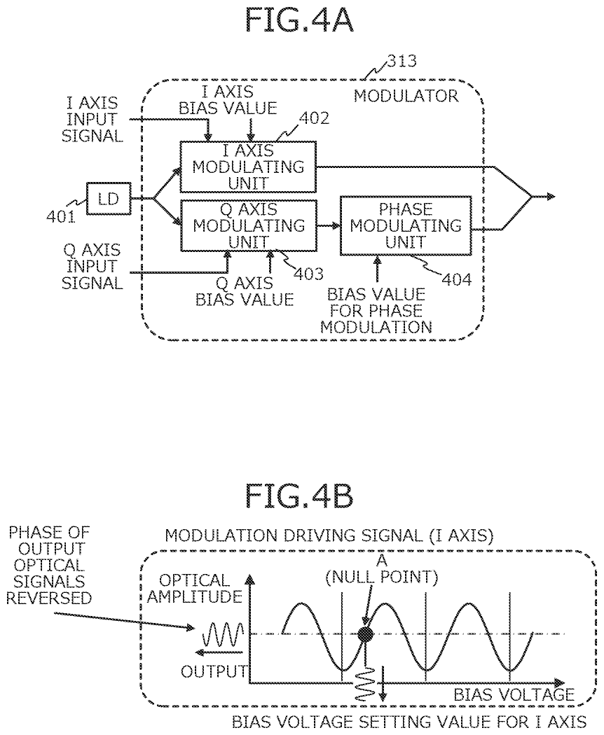

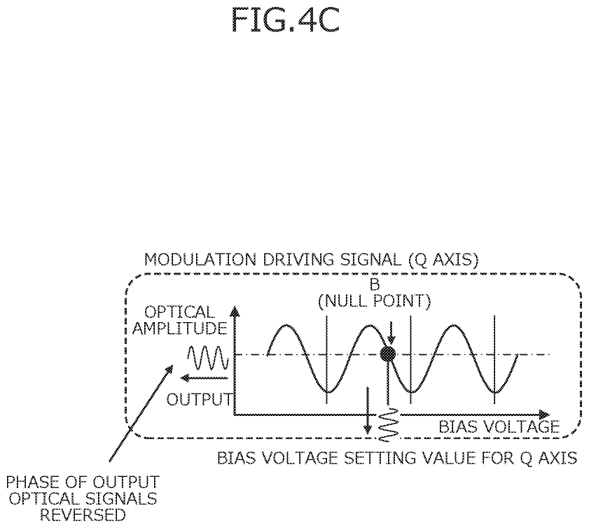

FIGS. 4A, 4B, and 4C are explanatory views of the modulator of the optical transmitter. FIG. 4A depicts a configuration example of the modulator. The modulator 313 is, for example, a Mach-Zehnder modulator in which light from a laser light source 401 is input to an I axis modulating unit 402 and a Q axis modulating unit 403. I axis and Q axis input signals are input as transmitting electrical signals, to the I axis modulating unit 402 and the Q axis modulating unit 403, respectively. The I axis and Q axis modulating units 402 and 403 each receive a bias value from the driver 312 to generate and output an optical signal obtained by modulating the input signal. Using the input bias value for phase modulation, a phase modulating unit 404 modulates the Q axis phase to match the I axis phase.

FIGS. 4B and 4C depict output states of optical signals from the I axis modulating unit 402 and the Q axis modulating unit 403, respectively. The horizontal and horizontal axes of the graphs represent bias voltage and amplitude of an optical signal, respectively. The modulator 313 makes adjustment so that signal distortion is minimized by bias control locking at null point under ABC control. Input signals in phase are input to the I axis and Q axis. Null points of I and Q axes are assumed as points A and B, respectively, in the diagram.

In this case, even though the same input signal is input, the phases of optical signals output from I and Q are inverted, respectively, in case of locking at point A of I axis and in case of locking at point B of Q axis.

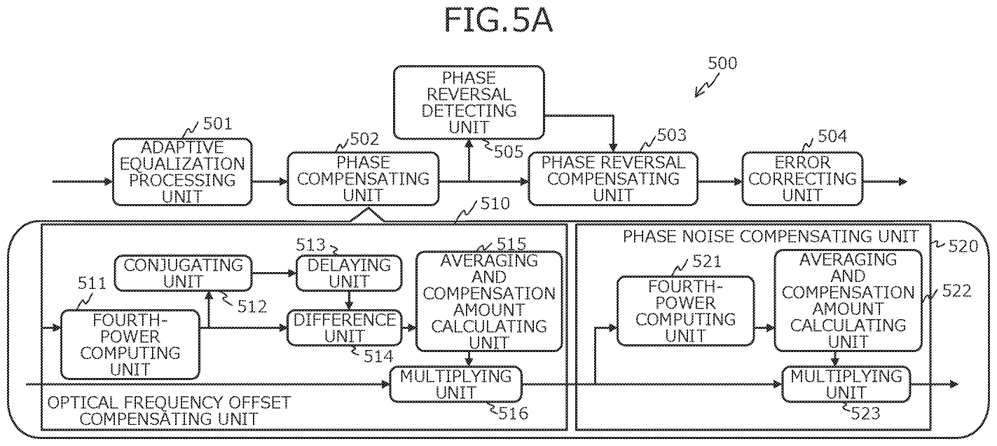

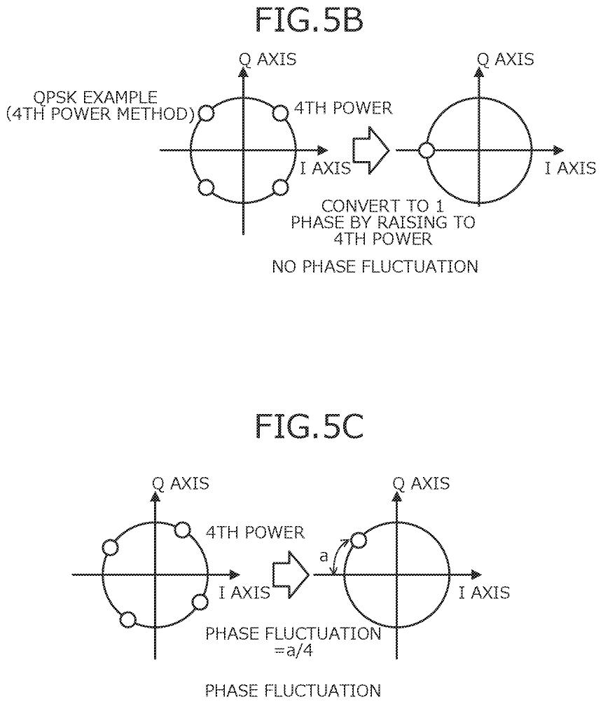

FIGS. 5A and 5B are explanatory views of the conventional phase compensation device based on n-th power method. N^{th}-power (fourth-power) phase compensation is described. FIG. 5A depicts a configuration of a conventional phase compensation device 500. For the input IQ received signal, the phase compensation device 500 allows connection to an adaptive equalization processing unit 501, a phase compensating unit 502, a phase reversal compensating unit 503, and an error correcting unit 504 in sequence.

This phase compensation device 500 includes a phase reversal detecting unit 505 connected for detecting phase reversal by an output branch of the phase compensating unit 502. The phase reversal compensating unit 503 performs phase compensation, based on a detection output of the phase reversal detecting unit 505. In this manner, in the conventional phase compensation device 500, the phase reversal detecting unit 505 is arranged posterior to the phase compensating unit 502.

The conventional phase compensation device 500 performs phase compensation based on the blind method, using data with modulated phase, by the phase compensating unit 502, before the phase reversal detection. In the conventional phase compensation device 500, the optical frequency offset compensating unit 510 is arranged at a stage upstream thereto, while the phase noise compensating unit 520 is arranged at a subsequent stage downstream therefrom.

The optical frequency offset compensating unit 510 includes a fourth-power computing unit 511, a conjugating unit (first conjugating unit) 512, a delaying unit 513, a differencing unit 514, an averaging and compensation amount calculating unit (first averaging and compensation amount calculating unit) 515, and a multiplying unit (first multiplying unit) 516.

The phase noise compensating unit 520 includes a fourth-power computing unit 521, an averaging and compensation amount calculating unit (second averaging and compensation amount calculating unit) 522, and a multiplying unit (second multiplying unit) 523.

FIG. 5B depicts an IQ constellation without phase fluctuation, while FIG. 5C depicts an IQ constellation with phase fluctuation. In the conventional phase compensation device 500, in an QPSK example, the received phase is converted (locked) into a specific phase by the fourth-power method computing processing, so that the phase compensation is feasible without being affected by the phase reversal of the received signal.

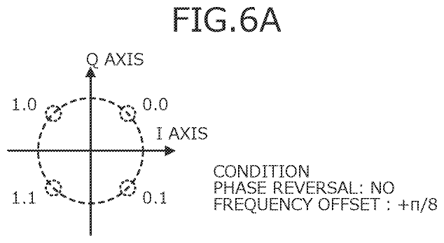

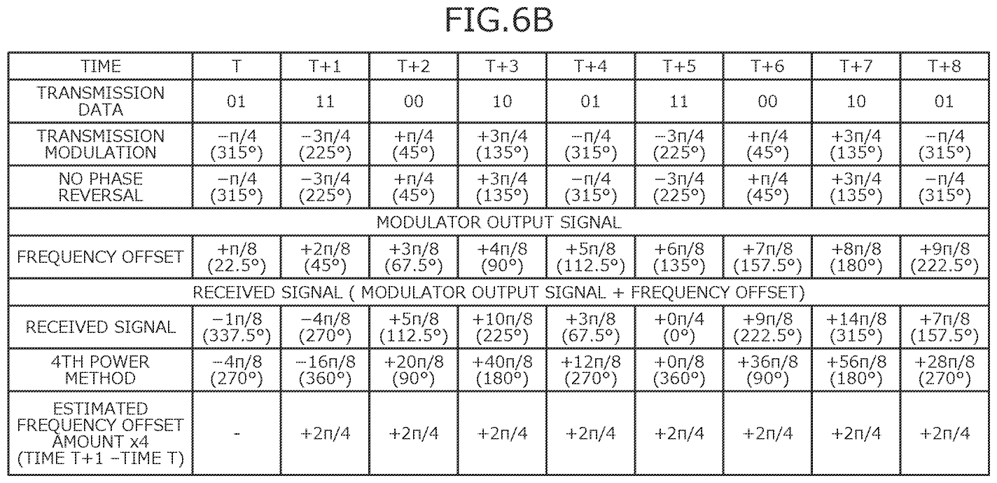

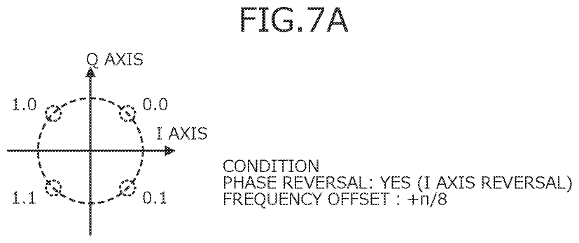

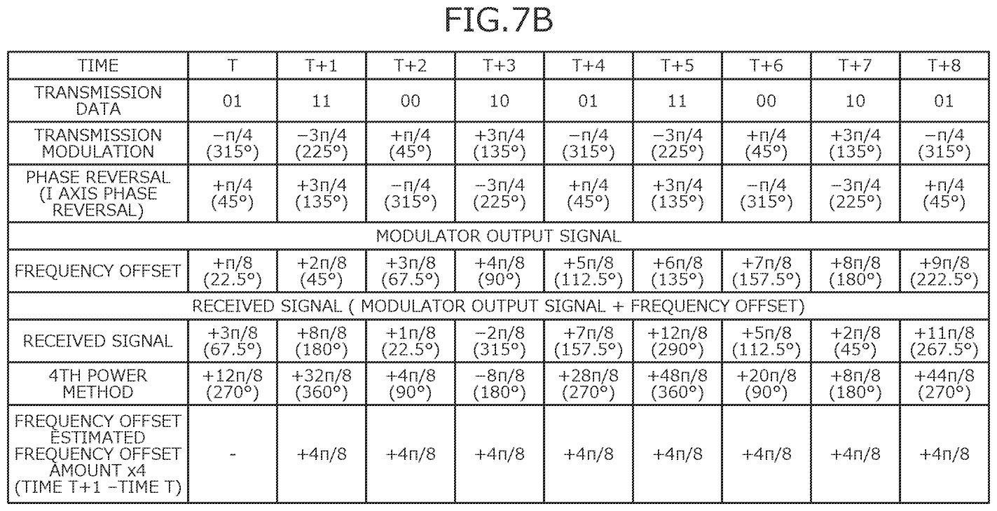

FIGS. 6A, 6B, 7A, and 7B are explanatory views of examples of frequency offset detection based on the conventional fourth-power method. In FIGS. 6A and 6B, the frequency offset detection example using the conventional phase compensation device 500 is depicted under the conditions in which the frequency offset is +π/8 without phase reversal by the modulator. FIG. 6A is a QPSK constellation diagram. The horizontal axis in the FIG. 6B represents time (T, T+1, T+2, . . . ). The vertical axis in FIG. 6B represents transmitting data (2-bit 00 to 11) of the optical transmitter 301 at each time, transmission modulation (angle), and modulator output signal of the modulator 313 without phase reversal (angle). The vertical axis in FIG. 6B further represents frequency offset at each time. The vertical axis in FIG. 6B further represents a received signal that is received by the optical receiver 303 at each time, fourth-power method (computing output), and frequency offset amount (frequency offset between symbols (time T+1)−(time T); multiplied by 4 in FIG. 6B). The received signal is given as modulator output signal+frequency offset. As depicted in FIG. 6B, use of the fourth-power method enables calculation (detection) of the expected frequency offset amount (+π/8) at each time.

Next, in FIGS. 7A and 7B, the frequency offset detection example using the conventional phase compensation device 500 is depicted under the conditions where the frequency offset is +π/8 with phase reversal (I axis reversal) by the modulator. FIG. 7A is a QPSK constellation diagram. The horizontal axis in FIG. 7B represents time (T, T+1, T+2, . . . ). The vertical axis in FIG. 7B represents transmitting data of the optical transmitter 301 at each time, transmission modulation (angle), and modulator output signal of the modulator 313 with phase reversal (I axis reversal). The vertical axis in FIG. 7B further represents frequency offset at each time. The vertical axis in FIG. 7B further represents received signal received by the optical receiver 303 at each time, fourth-power method (computing output), and estimated frequency offset amount (frequency offset between symbols (time T+1)−(time T); multiplied by 4 in FIG. 7B). As depicted in FIG. 6B, use of the fourth-power method enables calculation (detection) of the expected frequency offset amount (+4π/8) at each time.

In the conventional N^{th}-power method (fourth-power method), however, since the phase reversal detecting unit 505 that detects phase fluctuation is arranged downstream from the phase compensating unit 502, processing of raising the received electric field strength to the fourth-power by the phase compensating unit 502 before detecting phase reversal is necessary. For this reason, the conventional phase compensation device 500 has a problem of an increase in the amount of computing at the fourth-power computing units 511 and 521, leading to increased power consumption.

On the other hand, to suppress the power consumption without using the N^{th}-power method, the phase compensation device 100 of the embodiment performs phase compensation using a known signal.

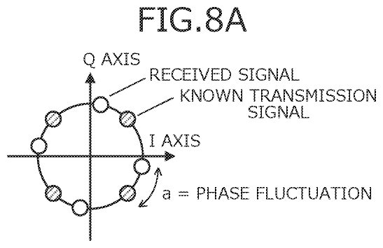

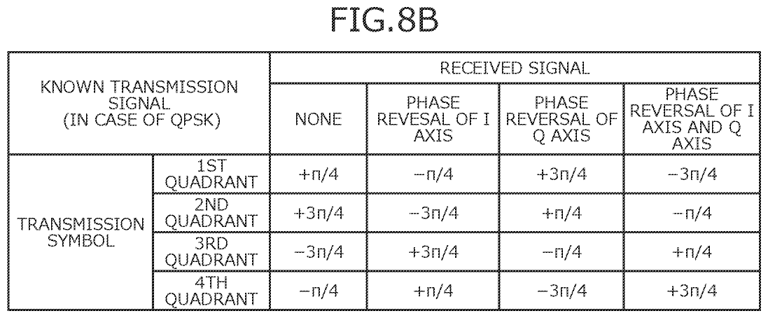

FIGS. 8A and 8B are explanatory views of phase compensation using a known signal. FIG. 8A depicts a QPSK constellation. FIG. 8B depicts a received signal in a case where phase reversals have occurred in a known QPSK transmission signal.

The phase compensation using a known symbol is a method of defining the difference between a transmitted known symbol and a received symbol as the phase noise amount. In the phase compensation using a known symbol, therefore, if phase reversal occurs, the transmitted known symbol is received as being in a symbol sequence different from the sequence of the transmitted known symbol, whereby the phase noise amount is misrecognized and functioning as phase compensation ceases.

Although to deal with this, it is conceivable to detect phase reversal before compensating phase fluctuation, this case needs a method of detecting phase reversal from a signal containing phase fluctuation. Phase fluctuation “a” of a received signal relative to a transmitted known signal depicted in FIG. 8A contains phase fluctuation arising from the frequency difference between transmission and reception lasers and phase fluctuation arising from phase noise.

Here, for example, the technique described in Japanese Laid-Open Patent Publication No. 2017-041666 is a technique using hard decision and when phase fluctuation is present, it cannot detect phase reversal correctly since the hard decision results contain a lot of decision errors.

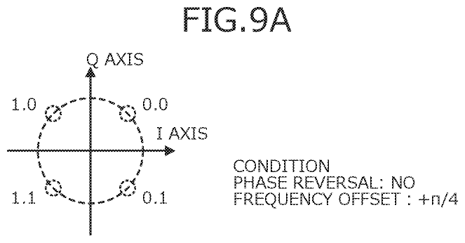

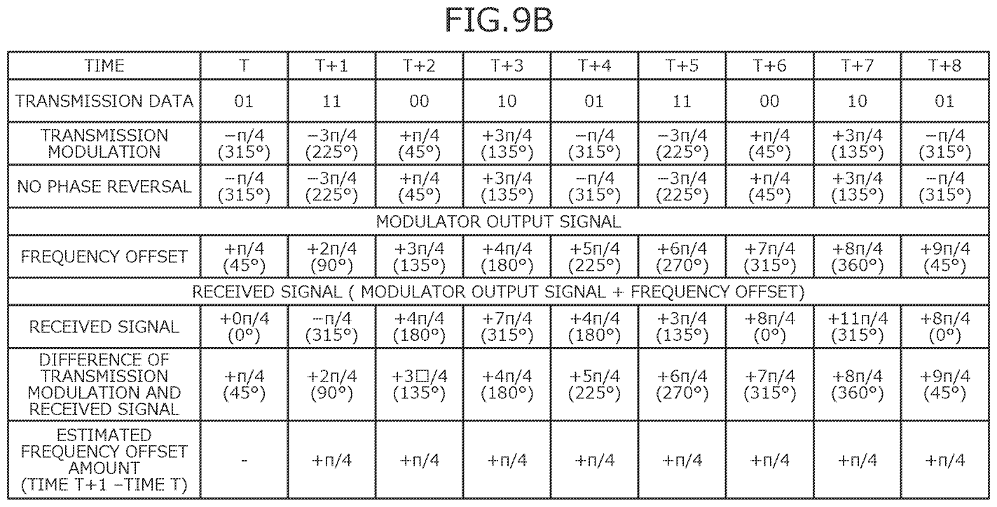

FIGS. 9A, 9B, 10A, 10B, 11A, 11B, 12A, and 12B are explanatory views of examples of frequency offset detection using a known signal. FIGS. 9A and 9B depict an example of conventional frequency offset detection using a known signal under conditions where the frequency offset is +π/4 without phase reversal by the modulator. FIG. 9A is a QPSK constellation diagram. The horizontal axis in FIG. 9B represents time (T, T+1, T+2, . . . ). The vertical axis in FIG. 9B represents transmitting data of the optical transmitter 301 at each time, transmission modulation (angle), and modulator output signal of the modulator 313 without phase reversal (angle). The vertical axis in FIG. 9B further represents frequency offset at each time. The vertical axis in FIG. 9B further represents a received signal that is received by the optical receiver 303 at each time, difference between transmission modulation and the received signal, and estimated frequency offset amount (frequency offset between symbols (time T+1)−(time T)). As depicted in FIG. 9B, use of the known signal enables calculation (detection) of the expected frequency offset amount (+π/4) at each time.

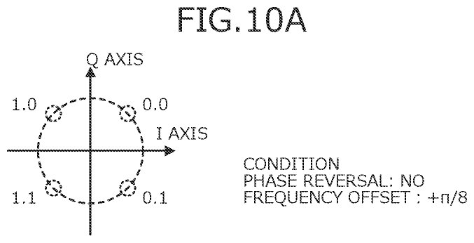

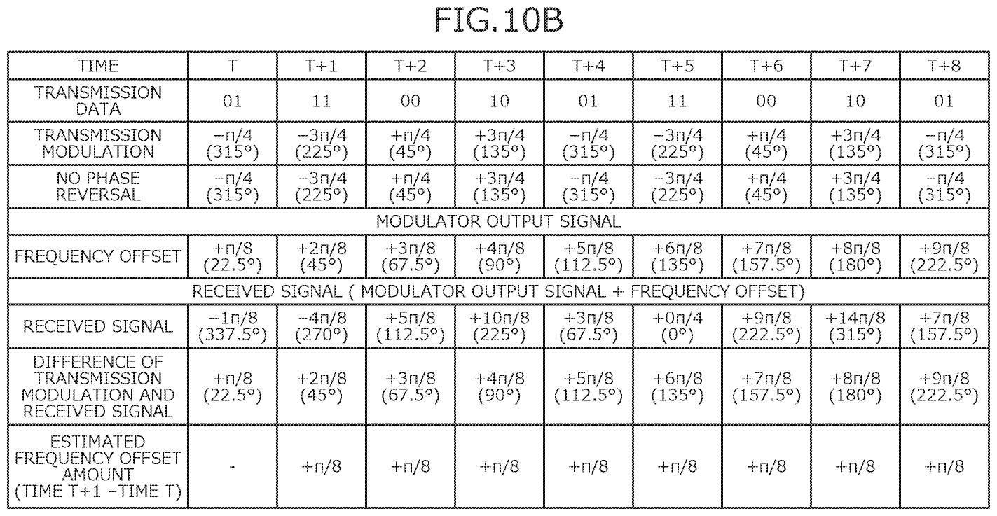

FIGS. 10A and 10B depict an example of conventional frequency offset detection using a known signal under conditions where the frequency offset is +π/8 without phase reversal by the modulator. FIG. 10A is a QPSK constellation diagram. The horizontal axis in FIG. 10B represents time (T, T+1, T+2, . . . ). The vertical axis in FIG. 10B represents transmitting data of the optical transmitter 301 at each time, transmission modulation (angle), and modulator output signal of the modulator 313 without phase reversal (angle). The vertical axis in FIG. 10B further represents frequency offset at each time. The vertical axis in FIG. 10B further represents s received signal that is received by the optical receiver 303 at each time, difference between transmission modulation and the received signal, and estimated frequency offset amount (frequency offset between symbols (time T+1)−(time T)). As depicted in FIG. 10B, use of the known signal enables calculation (detection) of the expected frequency offset amount (+π/8) at each time.

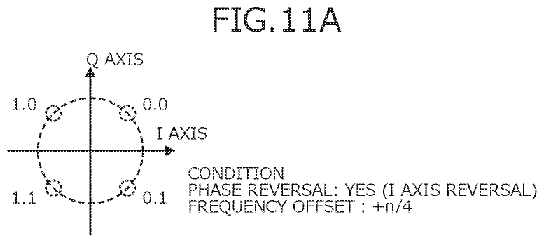

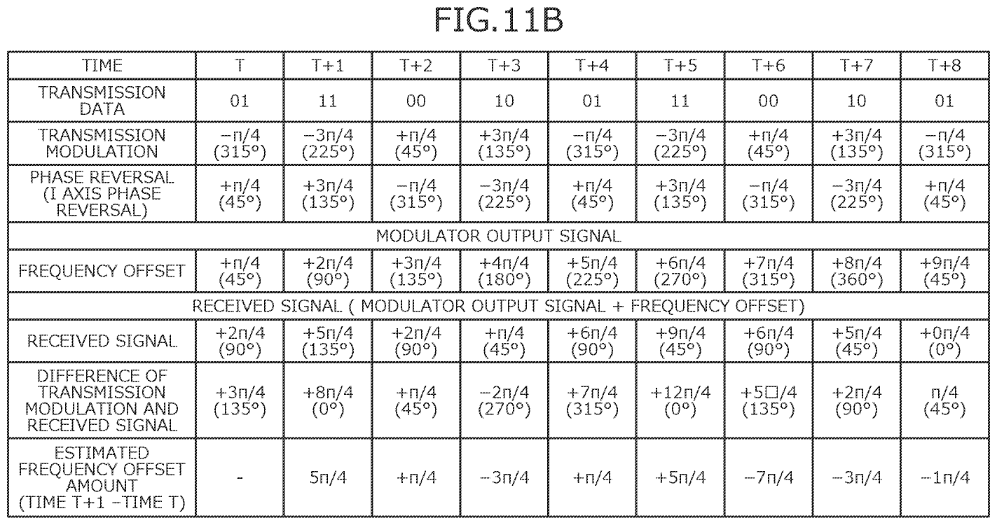

FIGS. 11A and 11B depict an example of conventional frequency offset detection using a known signal under conditions where the frequency offset is +π/4 with phase reversal (I axis reversal) by the modulator. FIG. 11A is a QPSK constellation diagram. The horizontal axis in FIG. 11B represents time (T, T+1, T+2, . . . ). The vertical axis in FIG. 11B represents transmitting data of the optical transmitter 301 at each time, transmission modulation (angle), and modulator output signal of the modulator 313 with I axis phase reversal (angle). The vertical axis in FIG. 11B further represents frequency offset at each time. The vertical axis in FIG. 11B further represents a received signal that is received by the optical receiver 303 at each time, difference between transmission modulation and received signal, and estimated frequency offset amount (frequency offset between symbols (time T+1)−(time T)). It may be seen in FIG. 11B that when phase reversal (I axis reversal) is present in case of using the known signal, expected frequency offset amount (+π/4) cannot be calculated (detected).

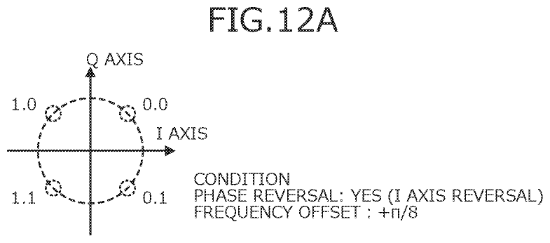

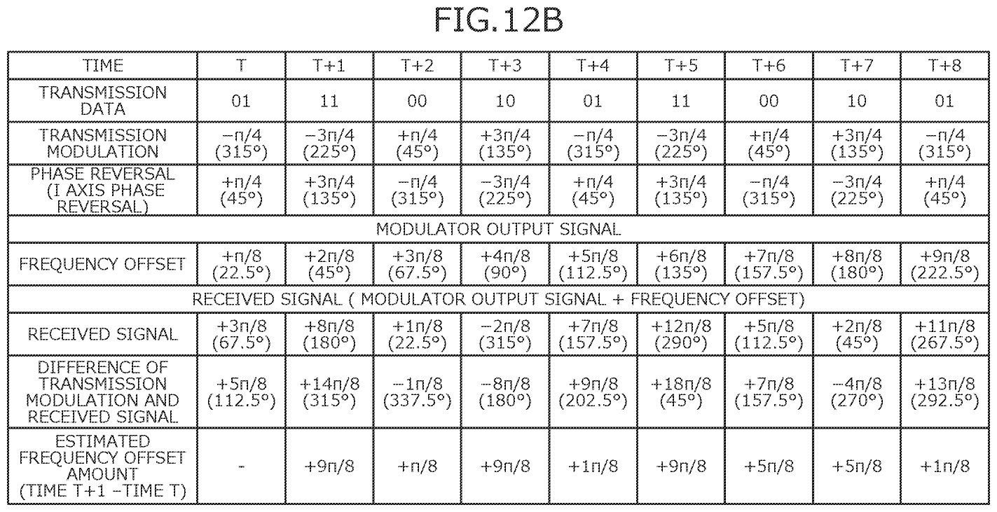

FIGS. 12A and 12B depict an example of conventional frequency offset detection using a known signal under conditions where the frequency offset is +π/8 with phase reversal (I axis reversal) by the modulator. FIG. 12A is a QPSK constellation diagram. The horizontal axis in FIG. 12B represents time (T, T+1, T+2, . . . ). The vertical axis in FIG. 12B represents transmitting data of the optical transmitter 301 at each time, transmission modulation (angle), and modulator output signal of the modulator 313 with I axis phase reversal (angle). The vertical axis in FIG. 12B further represents frequency offset at each time. The vertical axis in FIG. 12B further represents a received signal that is received by the optical receiver 303 at each time, difference between transmission modulation and received signal, and estimated frequency offset amount (frequency offset between symbols (time T+1)−(time T)). It may be seen in FIG. 12B that when phase reversal (I axis reversal) is present in case of using the known signal, expected frequency offset amount (+π/8) cannot be calculated (detected).

As described above, in case of conventional detection of frequency offset using a known signal, when the modulator output signal has no phase reversal, the frequency offset may be detected correctly as depicted in FIGS. 9A to 10B. When the modulator output signal has phase reversal, however, the frequency offset cannot be detected correctly as depicted in FIGS. 11A to 12B. In this manner, phase reversal has to be considered in detection of frequency offset using a known signal.

Details of the phase compensation device 100 of the embodiment is described. In the embodiment, phase compensation based on a known signal is implemented by correctly detecting phase fluctuation with consideration of phase reversal. For phase compensation using a known signal, the phase compensation device 100 of the embodiment detects phase reversal of a received signal by the phase reversal detecting unit 105 arranged upstream to the phase compensating unit 102, as depicted in FIG. 1.

In cases where in the phase compensation device 100 of the embodiment, phase reversal is detected by arranging the phase reversal detecting unit 105 upstream to the phase compensating unit 102, as depicted in FIG. 1, influences 1. and 2. below are considered.

### 1. Influence of Phase Fluctuation.

Since a stage upstream to the phase compensating unit 102 is affected by phase fluctuation, i.e., phase fluctuation arising from the frequency difference between transmission and reception lasers and phase fluctuation arising from phase noise, the received signal becomes unstable. To deal with this, the phase compensation device 100 needs phase reversal detection that is not affected by phase fluctuation.

### 2. Influence of ASE Noise on Transmission Line

The phase compensation device 100 needs phase reversal detection that takes into consideration, the influence of amplified spontaneous emission (ASE) on the transmission line.

To implement phase compensation using a known signal, the phase compensation device 100 of the embodiment has configurations of 3. and 4. below.

### 3. Insertion of Known Signal

To detect phase reversal by the optical receiver 303, the optical transmitter 301 inserts a known signal into a transmission signal, for transmission.

### 4. Configuration of Optical Receiver 303

In the optical receiver 303, the phase reversal detecting unit 105 is disposed upstream to the phase compensating unit 102, to detect phase reversal. The phase compensating unit 102 performs phase compensation using a known signal, to demodulate the transmission signal.

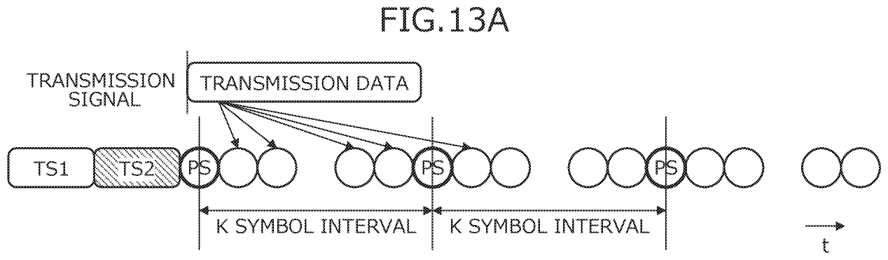

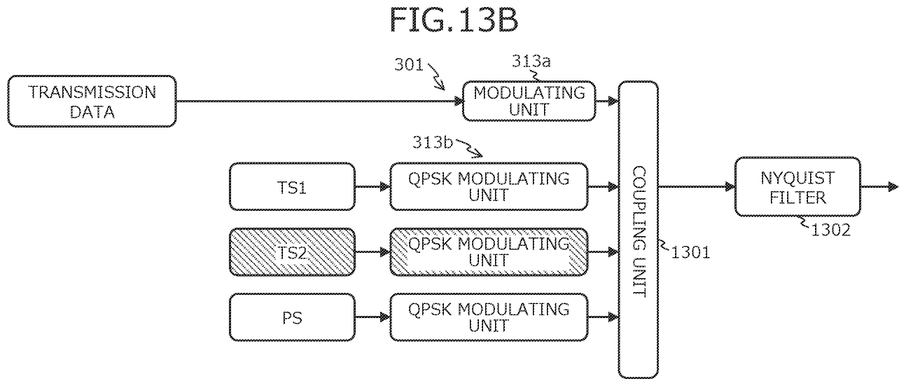

FIGS. 13A and 13B are explanatory views of insertion of a known signal into a transmission signal. FIG. 13A depicts a configuration example of a transmission signal transmitted from the optical transmitter 301. The horizontal axis represents time. The optical transmitter 301 transmits, as the transmission signal, transmitting data and a known signal (pilot signal) for phase compensation, to the optical receiver 303. The known signal includes a known signal (pilot signal) PS for phase compensation, a known signal TS1 for detecting PS, etc., and a known signal TS2 for detecting phase reversal. PS and TS are abbreviations for pilot signal and training signal, respectively.

As depicted in FIG. 13A, the optical transmitter 301 transmits the transmission signal with TS1 and the known signal (referred to as phase reversal determination signal) TS2 for phase reversal detection added to the head of the transmitting data. The optical transmitter 301 transmits the transmission signal with PS inserted into the transmitting data at regular intervals. The transmission signal (transmitting data, TS1, TS2, PS) transmitted from the optical transmitter 301 is received by the optical receiver 303. For example, the optical receiver 303 extracts the known signals from the photoelectrically converted received signal, stores the extracted signals to a storage, and refers to the known signals stored in the storage, as references, to perform phase compensation and phase reversal compensation of the received signal.

FIG. 13B depicts a configuration example of generation of a transmission signal in the optical transmitter 301. Transmitting data is modulated by a modulating unit 313a. TS1, TS2, and PS are each subjected to QPSK modulation at a QPSK modulating unit 313b. The transmitting data and TS1, TS2, and PS are coupled together via a coupling unit 1301 and output for transmission after bandwidth control by a Nyquist filter 1302. The known signal (phase reversal decision signal) TS2 is a signal that indicates the state of modulation by the QPSK modulating unit 313b of the optical transmitter 301.

An existing technique may be used for the configuration of inserting TS1 and PS into the transmission signal on the optical signal transmitting side. In the embodiment, the phase reversal decision signal TS2 may be contained in the data area of the existing TS1.

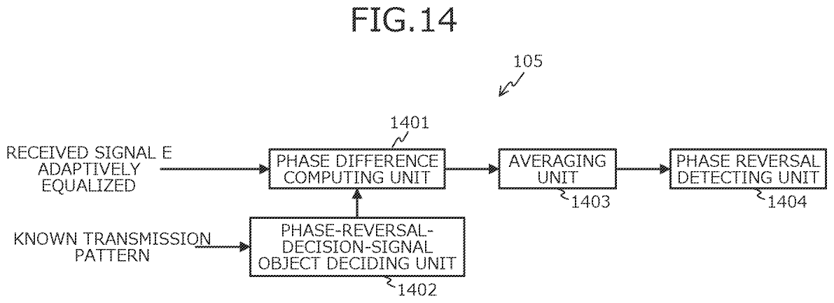

FIG. 14 is a view depicting a configuration example of the phase reversal detecting unit. In the phase compensation device 100 of the embodiment, the phase reversal detecting unit 105 is disposed upstream to the phase compensating unit 102 and detects phase reversal of a received signal. The phase compensation device 100 receives the known signal TS1 contained in the received signal and performs phase compensation and phase reversal compensation.

The phase reversal detecting unit 105 detects whether phase reversal has occurred in the received signal. For example, the optical receiver 303 (phase compensation device 100) extracts the known signals (TS1, TS2, and PS) contained in the transmission signal and stores to and holds the extracted signals in the storage. The phase reversal detecting unit 105 detects whether the received signal has phase reversal, on the basis of the known signal held in the storage, e.g., the phase reversal decision signal TS2. The storage may be, for example, a memory of the optical receiver 303. The optical receiver 303 performs phase compensation using the received PS and performs phase reversal compensation using the phase reversal decision signal TS2, to demodulate the received signal.

The phase reversal detecting unit 105 depicted in FIG. 14 includes a phase difference computing unit 1401, a phase-reversal-decision-signal object deciding unit 1402, an averaging unit 1403, and a phase reversal detecting unit 1404. The phase-reversal-decision-signal object deciding unit 1402 receives the known signal (phase reversal decision signal) TS2. The known signal TS2 is inserted into transmitting data and has a pattern (referred to as known transmission pattern) containing a combination of pieces of information concerning phase difference between two symbols for different times. The phase-reversal-decision-signal object deciding unit 1402 selects phase difference between two symbols of the received signal (received transmission signal) and phase difference between two symbols for comparison/correspondence with phase reversal detection of the received signal (received transmission signal) from among plural known signals TS2 contained in the known transmission pattern held in the storage.

Here, insertion of the plural known signals TS2 making up the known transmission pattern is not limited to collective insertion thereof into the transmission signal in the optical transmitter 301. The storage may previously store information concerning plural phase differences by time (by IQ axis quadrant) corresponding to known signals TS2 every two symbols at regular intervals.

The known transmission pattern is information concerning reference phase expected in the transmission signal modulated on the optical transmitter 301 side. The phase reversal detecting unit 105 refers to an expected known transmission pattern as a reference and detects whether the received signal has phase reversal, based on difference (Δαₜ) from the phase difference between two symbols of the received signal.

The phase difference computing unit 1401 calculates the phase change amount used for phase reversal detection, based on a received signal E adaptively equalized by the adaptive equalization processing unit 101 of the optical receiver 303 and position information concerning two symbols of the known signal (known transmission pattern) TS2 selected by the phase-reversal-decision-signal object deciding unit 1402. The averaging unit 1403 performs averaging processing for reducing noise of the output signal of the phase difference computing unit 1401. The phase reversal detecting unit 1404 detects the phase reversal state of the received signal and outputs the detected phase reversal state to the phase reversal compensating unit 103.

The phase reversal detecting unit 105 detects the phase reversal by utilizing the phase change amount between two symbols. Hence, the phase reversal detecting unit 105 detects phase reversal by utilizing the difference (Δαₜ) between the phase difference between two symbols obtained from the received adaptively equalized signal E depicted in FIG. 14 and the phase difference (expected phase difference) due to modulation of the transmission signal based on the known transmission pattern (TS2).

The transmission signal after modulation by the modulator in the optical transmitter 301 and the received signal after adaptive equalization processing in the optical receiver 303 are expressed as the following formulae.

Transmission signal: S(t)=s(t)e^{j}θ^{t}

Received signal: E(t)=s(t)e^{j(}θ^{t+}β^{t+}γ^{t+}δ^{t)}

Where, s(t): amplitude modulation component, θₜ: phase modulation component, βₜ: phase reversal component, γₜ: optical frequency offset component, and δₜ: phase noise component.

From the above, the received signal containing phase change is given as the formula below.

$$E ( t ) * {E ( t - 1 )}^{*} = s ( t ) s ( t - 1 ) {e}^{j ( ( {θ}^{t -} {θ}^{t - 1} ) + ( {β}^{t -} {β}^{t - 1} ) + ( {γ}^{t -} {γ}^{t - 1} ) + ( {δ}^{t -} {δ}^{t} ) )} = s ( t ) s ( t - 1 ) {e}^{j ( Δ {θ}^{t +} Δ {β}^{t +} Δ {γ}^{t +} Δ {δ}^{t} )} = s ( t ) s ( t - 1 ) {e}^{j ( Δ {θ}^{t +} Δ {α}^{t +} Δ {δ}^{t} )}$$

The phase difference between two symbols of the adaptively equalized known signal is affected by the following phase changes a. to c.
a. phase variation amount (expected phase difference) between two symbols due to modulation;
b. influence of phase reversal by the modulator; and
c. phase change amount due to optical frequency offset (influence of phase noise may be cancelled (Δδₜ=0) by taking a symbol-to-symbol difference in a short time period).

Therefore, Δαₜ=phase change amount due to influence of phase reversal by the modulator+phase change amount due to optical frequency offset.

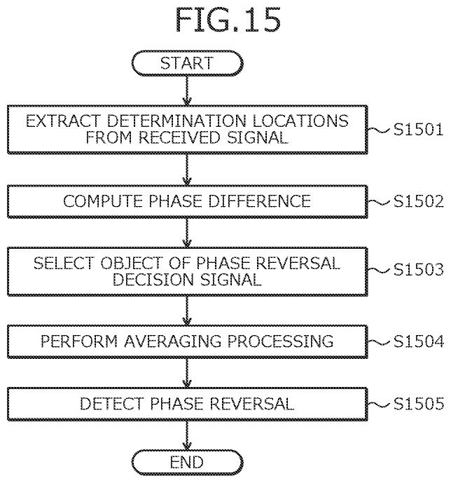

FIG. 15 is a flowchart depicting an example of phase reversal detection processing by the phase reversal detecting unit. The phase reversal detecting unit 105 described in FIG. 14 may perform phase reversal detection by executing a program on a processor, not limited to the above DSP, etc. In the configuration example using the processor, for example, phase reversal detection may be performed by storing data output from the adaptive equalization processing unit 101 depicted in FIG. 1 to the storage and then reading the data from the storage by the processor.

The processing example depicted in FIG. 15 corresponds to the configuration example of the phase reversal detecting unit 105 depicted in FIG. 14. First, the phase reversal detecting unit 105 extracts decision locations for phase reversal detection from the received signal (step S1501). Here, extracted as the decision locations are two symbols at different times of the received signal. The phase reversal detecting unit 105 then computes, for the extracted decision locations, a phase difference between two symbols from the received signal one symbol before (step S1502).

The phase reversal detecting unit 105 then refers to the known transmission pattern (TS2) and selects, from the known transmission pattern, an object of phase reversal decision signal used for phase reversal detection corresponding to the received signal at the extracted two symbols (step S1503). The phase reversal detecting unit 105 then refers to information concerning selected phase change amount and performs averaging processing for the phase difference computed at step S1502 (step S1504). The phase reversal detecting unit 105 then detects the state of phase reversal for the received signal (step S1505).

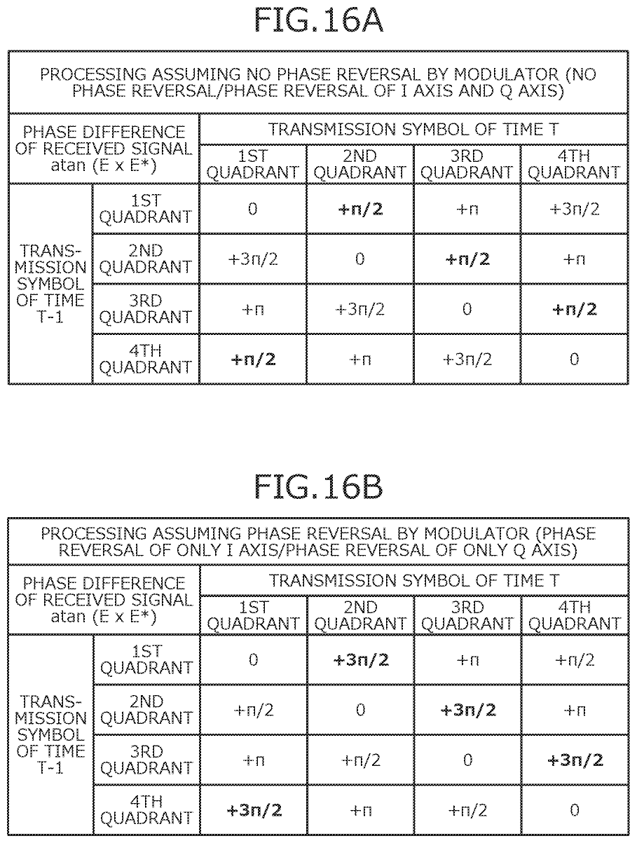

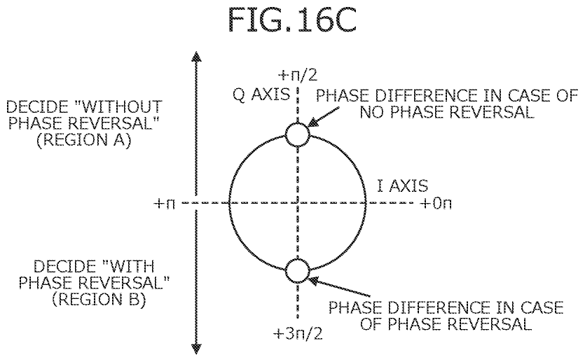

FIGS. 16A, 16B, and 16C are explanatory views of examples of phase reversal detection by the phase reversal detecting unit. In FIG. 16A to 16C, the frequency offset amount is assumed to be zero. FIG. 16A is a table depicting the phase change amount without phase reversal by the QPSK modulator of the optical transmitter 301. For example, in case of no phase reversal, the phase change amount of +π/2 lies between a first quadrant detection point of the transmission symbol at time T−1 and a second quadrant detection point of the transmission symbol at time T. FIG. 16A corresponds to the above cases of (1) without phase reversal and (4) with both I axis and Q axis phase reversals.

FIG. 16B is a table depicting the phase change amount with phase reversal by the QPSK modulator of the optical transmitter 301. For example, in case of having either the I axis reversal or the Q axis reversal, the phase change amount of +3π/2 lies between a first quadrant detection point of the transmission symbol at time T−1 and a second quadrant detection point of the transmission symbol at time T. FIG. 16A corresponds to the above cases of (3) with only the I axis phase reversal and (4) with only the Q axis phase reversal.

In FIGS. 16A and 16B, the horizontal axis represents quadrants of the transmission symbol at time T, while the vertical axis represents quadrants of the transmission symbol that is the transmission symbol (T−1) one symbol before. The phase reversal detecting unit 105 detects phase reversal by utilizing the phase change amount between two known symbols. In FIGS. 16A and 16B, as the above phase-reversal-decision-signal object decision, the phase reversal detecting unit 105 selects (refers to) only specific combinations of two symbols indicated in boldface in FIGS. 16A and 16B, for decision of phase change amount, from the storage. The phase reversal detecting unit 105 (phase difference computing unit 1401) computes the phase difference of the received signal from the combinations of the transmission symbols at time T and the transmission symbols (T−1) one symbol before, using, e.g., a tan(E×E*).

FIG. 16C depicts detection points on the I and Q axes of phase difference of the received signal. On the assumption of no frequency offset (γ=0), the phase reversal detecting unit 105 decides the state as “without phase reversal” in a region A. The detection point without phase reversal lies at +π/2. The phase reversal detecting unit 105 decides the state as “with phase reversal” in a region B. The detection point with phase reversal lies at +3π/2.

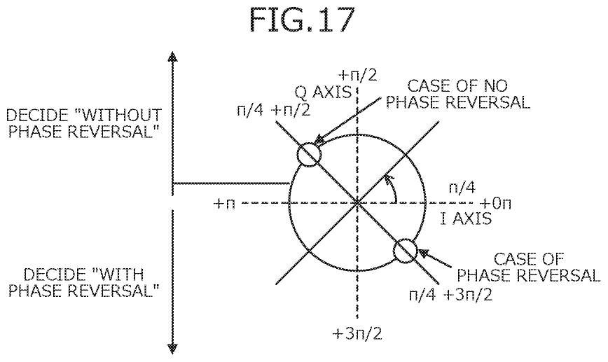

FIG. 17 is an explanatory view of an example of phase reversal detection effected by the phase reversal detecting unit. FIG. 17 depicts the I and Q axes when frequency offset is present. As described above, the difference Δαₜ between actually detected phase differences contains the frequency offset amount. For this reason, the detection points vary between, for example, the case where phase reversal is present by the frequency offset (π/4) depicted in FIG. 17 and the case where phase reversal is absent depicted in FIG. 16C.

Here, since the decision conditions for phase reversal detection do not change, the phase reversal detecting unit 105 may detect phase reversal when frequency offset<±π/2 is satisfied. A case of large frequency offset may be handled by using a technique of reducing the frequency offset when detecting by rough estimation (see, for example, Japanese Laid-Open Patent Publication No. 2011-228819).

Operation examples with and without phase reversal in the phase compensation device of the embodiment are described. Hereinafter, configuration units similar to those in FIG. 1 are given the same reference numerals used in FIG. 1.

Corresponding to the overview explanation of FIG. 2, the phase compensating unit 102 of the embodiment is described in regard to (1) the case without phase reversal (operation example 1 below) and (4) the case of occurrence of both I axis and Q axis phase reversals (operation example 2). Further, (2) the case of occurrence of only I axis phase reversal (operation example 3) and (3) the case of occurrence of only I axis phase reversal (operation example 4) are also described.

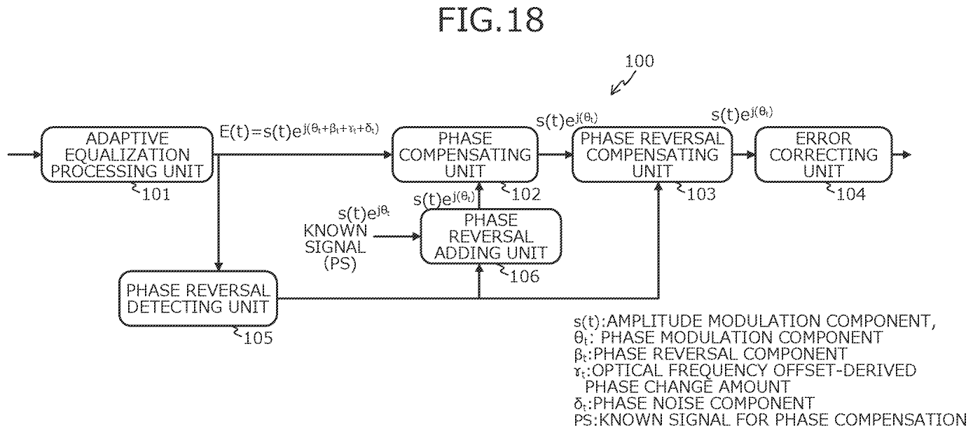

FIG. 18 is a diagram depicting an operation example of the phase compensation device in the case of no occurrence of phase reversal. Contents of processing data are described on the configuration units and signal paths of FIG. 18. In FIG. 18, definitions are as follows: s(t): amplitude modulation component, θₜ: phase modulation component, βₜ: phase reversal component, γₜ: optical frequency offset-derived phase change amount, δₜ: phase noise component, and PS: known signal for phase compensation.

Description is given assuming a case where no phase reversal has occurred (βₜ=0) by the modulator of the optical transmitter 301. The phase reversal detecting unit 105 decides that phase reversal is not occurring. The phase reversal adding unit 106 regards phase reversal as not occurring and outputs the input signal as it is. For the signal (E(t)) adaptively equalized by the adaptive equalization processing unit 101, the phase compensating unit 102 utilizes the output of the phase reversal adding unit 106 and estimates the optical frequency offset-derived phase change amount (γₜ) and the phase noise amount (δₜ). The phase compensating unit 102 performs phase compensation by utilizing the estimated results.

For the signal after phase compensation by the phase compensating unit 102, the phase reversal compensating unit 103 performs phase reversal compensation based on the result of the phase reversal detecting unit 105. In operation example 1, phase reversal does not occur and thus, the input signal is output intactly.

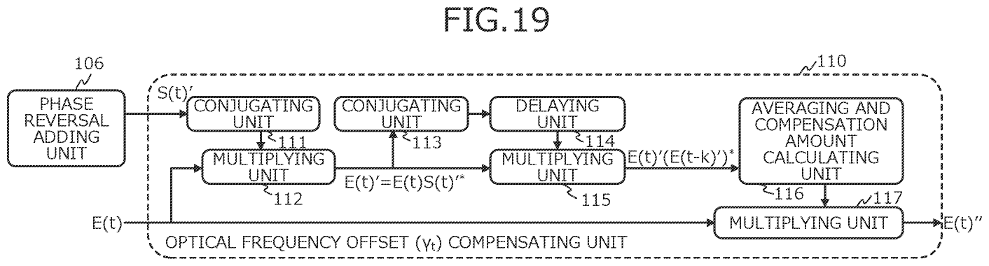

FIG. 19 is a view depicting operation of the optical frequency offset compensating unit in operation example 1. The optical frequency offset compensating unit 110 utilizes a pilot of the received signal and a pilot of the transmission signal to estimate the phase change amount derived from the optical frequency offset, to thereby perform optical frequency offset compensation expressed by the following formula, using the estimated result.

S(t)′=S(t)e^{j}θ^{t}

E(t)=s(t)e^{j(}θ^{t+}β^{t+}γ^{t+}δ^{t)}

E(t)′=E(t)(S(t)′)*=s(t)e^{j(}θ^{t+}β^{t+}γ^{t+}δ^{t)}(s(t)e^{j}θ^{t})*=s(t)e^{j(}θ^{t+}β^{t+}γ^{t+}δ^{t)}s(t)e^{-j}θ^{t}=s(t)²e^{j(}β^{t+}γ^{t+}δ^{t)}

Influence of phase noise may be cancelled (δₜ−δₜ₋ₖ=0) by taking a symbol-to-symbol difference in a short time period (time t and time t−k, k:pilot interval).

E(t)′(E(t−k)′)*=s(t)²e^{j(}β^{t+}γ^{t+}δ^{t)}s(t−k)²e^{-j(}β^{t-k+}γ^{t-k+}δ^{t-k)}=s(t)²s(t−k)²e^{j(}β^{t-}β^{t-k+}γ^{t-}γ^{t-k+}δ^{t-}δ^{t-k)}

δₜ−δₜ₋ₖ=0 and βₜ=0, and thus, βₜ−βₜ₋ₖ=0 is satisfied, whereby the following is true.

E(t)′(E(t−k)′)*=s(t)²s(t−k)²e^{j(}γ^{t-}γ^{t-k)}=s(t)²s(t−k)²e^{j}Δγ^{t}

Since Δγₜ as the laser frequency difference between transmission and reception has a small timewise variation, the optical frequency offset compensating unit 110 averages E(t)′(E(t−k)′)* to reduce noise and then calculates the compensation amount per symbol. In this example, since the variation amount at k symbol is Δγₜ, the change amount per symbol results in Δγₜ/k obtained by multiplying Δγₜ by 1/k. Therefore, the compensation amount per symbol results in −Δγₜ/k=−Δγₜ (k: pilot interval).

The optical frequency offset compensating unit 110 compensates E(t) by utilizing the above value. The optical frequency offset at certain time T may be expressed as follows using phase change amount γ′ of the optical frequency offset at certain timing and Δγ that is the phase variation amount per symbol.

γₜ=γ′+Δγ×t

γ′ is a fixed amount and thus, may be considered as a part of the phase noise component (δₜ). As a result, received data E(t)″ after optical frequency offset compensation may be expressed as follows.

E(t)″=s(t)e^{j(}θ^{t+}β^{t+}Δγ×^{t+}δ^{t)}×e^{j(-}Δγ×^{t)}=s(t)e^{j(}θ^{t+}β^{t+}δ^{t)}

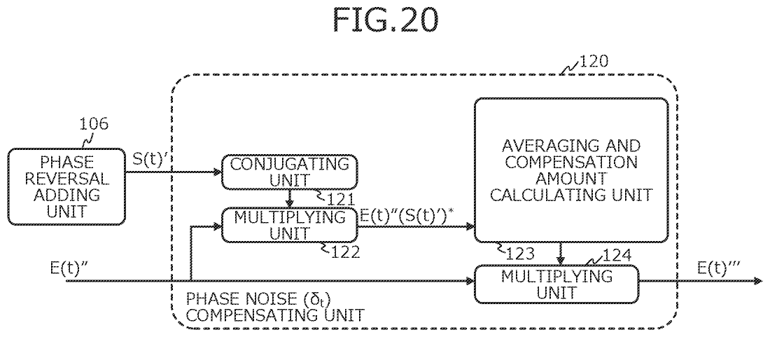

FIG. 20 is a diagram depicting operation of the phase noise compensating unit in operation example 1. For the signal after optical frequency offset compensation at the optical frequency offset compensating unit 110, the phase noise compensating unit 120 performs phase noise compensation by using a pilot signal PS considering phase reversal.

S(t)′=S(t)=s(t)e^{j}θ^{t}

E(t)″=s(t)e^{j(}θ^{t+}β^{t+}δ^{t)}

E(t)″(S(t)′)*=s(t)e^{j(}θ^{t+}β^{t+}δ^{t)}(s(t)e^{j}θ^{t})*=s(t)e^{j(}θ^{t+}β^{t+}δ^{t)}s(t)e^{-j}θ^{t}=s(t)²e^{j(}β^{t+}δ^{t)}

The phase noise (δₜ) is given as follows (δₜ=δ, βₜ=0=β) since the phase noise (δₜ) may be regarded as constant in case of a short time period and the phase reversal amount (βₜ) by the modulator is a fixed value.

E(t)″(S(t)′)*=s(t)²e^{j(}β^{t+}δ^{t)}=s(t)²e^{j(}β⁺δ⁾

Since E(t)″(S(t)′)* may be regarded as having a constant phase change amount in case of a short time period, the phase noise compensating unit 120 averages the results of E(t)″(S(t)′)* to reduce noise, to calculate the compensation amount.

The compensation amount by the phase noise compensating unit 120 is a value obtained by multiplying the averaged phase amount by −1. Since the time period to calculate a compensation coefficient and the time period to apply the compensation coefficient are short, a relationship of δₜ=δ is established. Since the phase reversal amount by the modulator is fixed (βₜ=β), the following formula holds.

E(t)′″=E(t)″×e^{-j(}β^{t+}δ^{t)}=s(t)e^{j(}θ^{t+}β^{t+}δ^{t)}×e^{-j(}β^{t+}δ⁾=s(t)e^{j(}θ^{t+}β^{t+}δ⁾×e^{-j(}β⁺δ⁾=s(t)e^{j(}θ^{t)}=S(t)

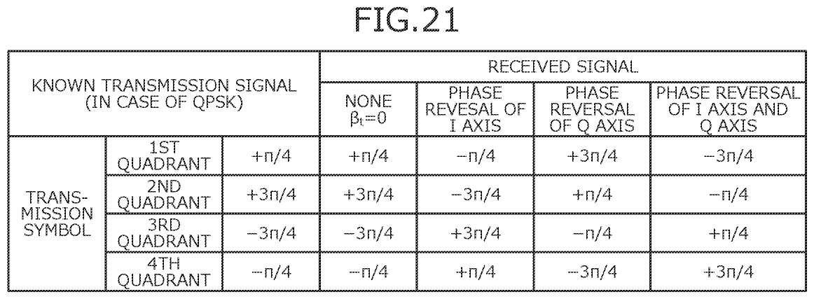

FIG. 21 is a table for explaining action of the phase reversal compensating unit in operation example 1. The phase reversal compensating unit 103 performs compensation, based on the result of phase reversal detection by the phase reversal detecting unit 105. Here, since the phase reversal detecting unit 105 decides that phase reversal is not occurring, the phase reversal compensating unit 103 outputs the input signal as it is.

E(t)′″=S(t)

As described above, operation example 1 demonstrates that the phase compensation device 100 may demodulate the received signal correctly.

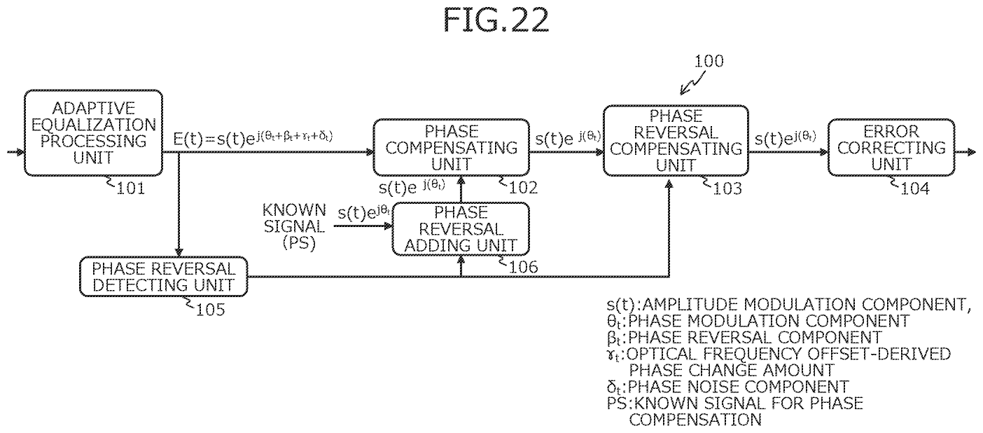

FIG. 22 is a diagram depicting an operation example of the phase compensation device in the case where I axis and Q axis phase reversals have occurred.

Description is given assuming a case where both the I axis and Q axis phase reversals have occurred (βₜ=π) by the modulator of the optical transmitter 301. In this case, the phase reversal detecting unit 105 decides that phase reversal is not occurring. The phase reversal adding unit 106 regards phase reversal as not occurring and outputs the input signal as it is. For the signal (E(t)) adaptively equalized by the adaptive equalization processing unit 101, the phase compensating unit 102 utilizes the output of the phase reversal adding unit 106 to estimate the optical frequency offset-derived phase change amount (γₜ) and the phase noise amount (δₜ). The phase compensating unit 102 performs phase compensation by utilizing the estimated results.

For the signal after phase compensation, the phase reversal compensating unit 103 performs phase reversal compensation based on the result of the decision of the phase reversal detecting unit 105. In operation example 2, phase reversal is regarded as not occurring to allow intact output of the input signal.

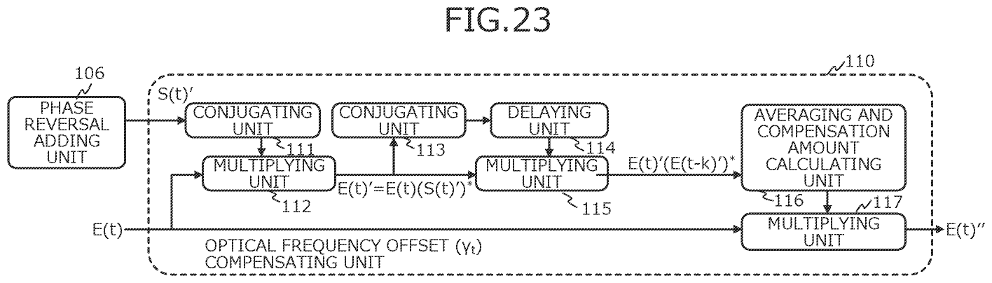

FIG. 23 is a view depicting action of the optical frequency offset compensating unit in operation example 2. The optical frequency offset compensating unit 110 utilizes a pilot of the received signal and a pilot of the transmission signal, to estimate the phase change amount of the optical frequency offset and thereby perform optical frequency offset compensation expressed by the following formula, using the estimated result.

S(t)′=S(t)=s(t)e^{j}θ^{t}

E(t)=s(t)e^{j(}θ^{t+}β^{t+}γ^{t+}δ^{t)}

E(t)′=E(t)(S(t)′)*=s(t)e^{j(}θ^{t+}β^{t+}γ^{t+}δ^{t)}(s(t)e^{j}θ^{t})*=s(t)e^{j(}θ^{t+}β^{t+}γ^{t+}δ^{t)}s(t)e^{-j}θ^{t}=s(t)²e^{j(}β^{t+}γ^{t+}δ^{t)}

Influence of phase noise may be cancelled (δₜ−δₜ₋ₖ=0) by taking a symbol-to-symbol difference in a short time period (time t and time t−k, k: pilot interval).

E(t)′(E(t−k)′)*=s(t)²e^{j(}β^{t+}γ^{t+}δ^{t)}s(t−k)²e^{-j(}β^{t-k+}γ^{t-k+}δ^{t-k)}=s(t)²s(t−k)²e^{j(}β^{t-}β^{t-k+}γ^{t-}γ^{t-k+}δ^{t-}δ^{t-k)}

δₜ−δₜ₋ₖ=0 and βₜ=0, and thus, βₜ−βₜ₋ₖ=0 is satisfied, whereby the following is true.

E(t)′(E(t−k)′)*=s(t)²s(t−k)²e^{j(}γ^{t-}γ^{t-k)}=s(t)²s(t−k)²e^{j}Δγ^{t}

Since Δγₜ, which is the laser frequency difference between transmission and reception, has a small timewise variation, the optical frequency offset compensating unit 110 averages E(t)′(E(t−k)′)* to reduce noise, and then calculates the compensation amount per symbol. In this example, since the variation amount at k symbol is Δγₜ, the change amount per symbol results in Δγₜ/k obtained by multiplying Δγₜ by 1/k. Therefore, the compensation amount per symbol results in −Δγₜ/k=−Δγₜ (k: pilot interval).

The optical frequency offset compensating unit 110 compensates E(t) by utilizing the above value. The optical frequency offset at a certain time T may be expressed as follows using phase change amount γ′ of the optical frequency offset at certain timing and Δγ, which is the phase variation amount per symbol.

γₜ=γ′+Δγ×t

γ′ is a fixed amount and thus, may be considered as a part of the phase noise component (δₜ). As a result, received data E(t)″ after optical frequency offset compensation can be expressed as follows.

E(t)″=s(t)e^{j(}θ^{t+}β^{t+}Δγ×^{t+}δ^{t)}×e^{j(-}Δγ×^{t)}=s(t)e^{j(}θ^{t+}β^{t+}δ^{t)}

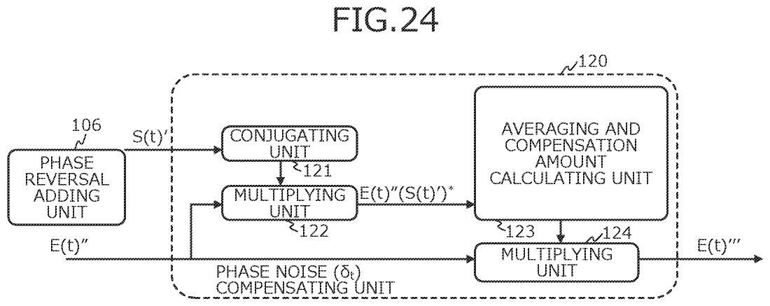

FIG. 24 is a diagram depicting operation of the phase noise compensating unit in operation example 2. For the signal after optical frequency offset compensation, the phase noise compensating unit 120 performs phase noise compensation by using a pilot signal PS considering phase reversal.

S(t)′=S(t)=s(t)e^{j}θ^{t}

E(t)″=s(t)e^{j(}θ^{t+}β^{t+}δ^{t)}

E(t)″(S(t)′)*=s(t)e^{j(}θ^{t+}β^{t+}δ^{t)}(s(t)e^{j}θ^{t})*=s(t)e^{j(}θ^{t+}β^{t+}δ^{t)}s(t)e^{-j}θ^{t}=s(t)²e^{j(}β^{βt+}δ^{t)}

The phase noise (δₜ) is given as follows (δₜ=δ, βₜ=−π=β) since the phase noise (δₜ) may be regarded as constant in a case of a short time period and the phase reversal amount (βₜ) by the modulator is a fixed value.

E(t)″(S(t)′)*=s(t)²e^{j(}β^{t+}δ^{t)}=s(t)²e^{j(}β⁺δ⁾

Since E(t)″(S(t)′)* may be regarded as having a constant phase change amount in a case of a short time period, the phase noise compensating unit 120 averages the results of E(t)″(S(t)′)* to reduce noise, to calculate the compensation amount.

The compensation amount by the phase noise compensating unit 120 is a value obtained by multiplying the averaged phase amount by −1. Since the time period to calculate a compensation coefficient and the time period to apply the compensation coefficient are short, a relationship of δₜ=δ is established. Since the phase reversal amount by the modulator is fixed (βₜ=β), the following formula holds.

E(t)′″=E(t)″×e^{-j(}β⁺δ^{t)}=s(t)e^{j(}θ^{t+}β^{t+}δ^{t)}×e^{-j(}β⁺δ⁾==s(t)e^{j(}θ^{t+}β⁺δ⁾×e^{-j(}β⁺δ⁾=s(t)e^{j(}θ^{t)}=S(t)

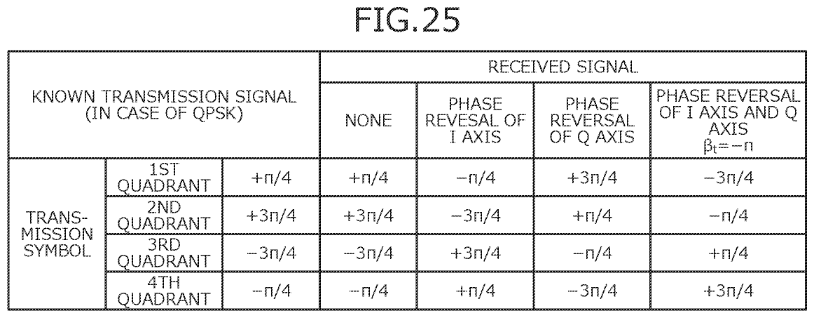

FIG. 25 is a table for explaining operation of the phase reversal compensating unit in operation example 2. The phase reversal compensating unit 103 performs compensation, based on the result of phase reversal detection by the phase reversal detecting unit 105. Here, since the phase reversal detecting unit 105 decides that phase reversal is not occurring, the phase reversal compensating unit 103 outputs the input signal as it is.

E(t)′″=S(t)

As described above, example 2 demonstrates that the phase compensation device 100 may demodulate the received signal correctly.

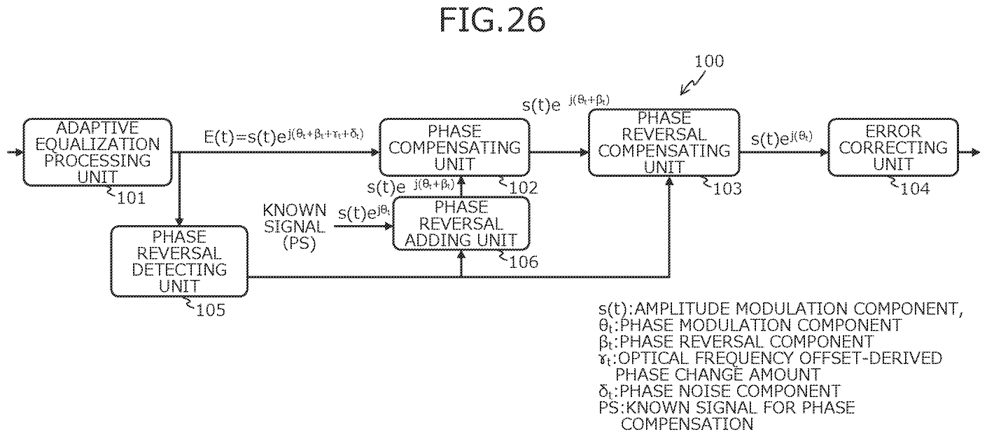

FIG. 26 is a diagram depicting operation example of the phase compensation device in the case where only I axis phase reversal has occurred.

Description is given assuming a case where only the I axis phase reversal has occurred by the modulator of the optical transmitter 301. In this case, the phase reversal detecting unit 105 decides that phase reversal is occurring, due to occurrence of only I axis phase reversal. Based on the decision of the phase reversal detecting unit 105 that phase reversal is present, the phase reversal adding unit 106 regards phase reversal as occurring and issues a signal with consideration of I axis phase reversal.

For the signal (E(t)) adaptively equalized by the adaptive equalization processing unit 101, the phase compensating unit 102 estimates the optical frequency offset-derived phase change amount (γₜ) and the phase noise amount (δₜ) by utilizing the output signal of the phase reversal adding unit 106. The phase compensating unit 102 performs phase compensation by utilizing the estimated results.

For the signal after phase compensation effected by the phase compensating unit 102, the phase reversal compensating unit 103 performs phase reversal compensation based on the result of the decision of the phase reversal detecting unit 105. In operation example 3, I axis phase reversal is regarded as occurring and compensation is performed.

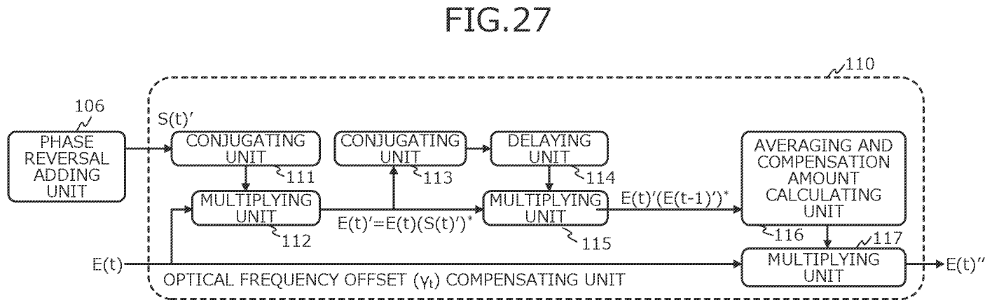

FIG. 27 is a view depicting operation of the optical frequency offset compensating unit in operation example 3. The optical frequency offset compensating unit 110 utilizes a pilot of the received signal and a pilot of the transmission signal, to estimate the phase change amount of the optical frequency offset and thereby perform optical frequency offset compensation expressed by the following formula, using the estimated result.

S(t)′=S(t)e^{j(}β^{t)}=s(t)e^{j(}θ^{t+}β^{t)}

E(t)=s(t)e^{j(}θ^{t+}β^{t+}γ^{t+}δ^{t)}

E(t)′=E(t)(S(t)′)*=s(t)e^{j(}θ^{t+}β^{t+}γ^{t+}δ^{t)}(s(t)e^{j(}θ^{t+}β^{t)})*=s(t)e^{j(}θ^{t+}β^{t+}γ^{t+}δ^{t)}s(t)e^{-j(}θ^{t+}β^{t)}=s(t)²e^{j(}γ^{t+}δ^{t)}

Influence of phase noise can be cancelled (δₜ−δₜ₋ₖ=0) by taking a symbol-to-symbol difference in a short time period (time t and time t−k, k:pilot interval).

E(t)′(E(t−k)′)*=s(t)²e^{j(}γ^{t+}δ^{t)}s(t−k)²e^{-j(}γ^{t-k)+}δ^{t-k)}=s(t)²s(t−k)²e^{j(}γ^{t-}γ^{t-k+}δ^{t-}δ^{t-k)}

δₜ−δₜ₋ₖ=0 is satisfied and thus, the following is true.

E(t)′(E(t−k)′)*=s(t)²s(t−k)²e^{j(}γ^{t-}γ^{t-k)}=s(t)²s(t−k)²e^{j}Δγ^{t}

Since Δγₜ, which is the laser frequency difference between transmission and reception, has a small timewise variation, the optical frequency offset compensating unit 110 averages E(t)′(E(t)′)* to reduce noise, and then calculates the compensation amount per symbol. In this example, since the variation amount at k symbol is Δγₜ, the change amount per symbol results in Δγₜ/k obtained by multiplying Δγₜ by 1/k. Therefore, the compensation amount per symbol results in −Δγₜ/k=−Δγₜ (k: pilot interval).

The optical frequency offset compensating unit 110 compensates E(t) by utilizing the above value. The optical frequency offset at a certain time T may be expressed as follows using phase change amount γ′ of the optical frequency offset at certain timing and Δγ that is the phase variation amount per symbol.

γₜ=γ′+Δγ×t

γ′ is a fixed amount and thus, may be considered as a part of the phase noise component (δₜ). As a result, received data E(t)′ after optical frequency offset compensation may be expressed as follows.

E(t)″=s(t)e^{j(}θ^{t+}β^{t+}Δγ×^{t+}δ^{t)}×e^{J(-}Δγ×^{t)}=s(t)e^{j(}θ^{t+}β^{t+}δ^{t)}

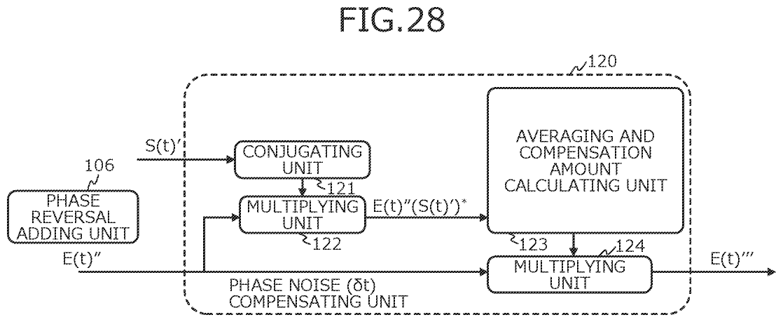

FIG. 28 is a diagram depicting operation of the phase noise compensating unit in operation example 3. For the signal after optical frequency offset compensation, the phase noise compensating unit 120 performs phase noise compensation by using a known transmission signal as a pilot considering phase reversal.

S(t)′=S(t)e^{j(}β^{t)}=s(t)e^{j(}θ^{t+}β^{t)}

E(t)″=s(t)e^{j(}θ^{t+}β^{t+}δ^{t)}

E(t)″(S(t)′)*=s(t)e^{j(}θ^{t+}β^{t+}δ^{t)}(s(t)e^{j(}θ^{t+}β^{t)})*=s(t)e^{j(}θ^{t+}β^{t+}δ^{t)}s(t)e^{-j(}θ^{t+}β^{t)}=s(t)²e^{j(}δ^{t)}

Phase noise may be regarded as constant (δₜ=δ) in a case of a short time period.

E(t)″(S(t)′)*=s(t)²e^{j(}δ^{t)}=s(t)²e^{j(}δ⁾

Since E(t)″(S(t)′)* may be regarded as having constant phase change amount in case of a short time period, the phase noise compensating unit 120 averages the results of E(t)″(S(t)′)* to reduce noise, to calculate the compensation amount.

The compensation amount by the phase noise compensating unit 120 is a value obtained by multiplying the averaged phase amount by −1. Since the time period to calculate a compensation coefficient and the time period to apply the compensation coefficient are short, a relationship of δₜ=δ is established as follows.

E(t)′″=E(t)″×e^{-j(}δ^{t)}=s(t)e^{j(}θ^{t+}β^{t+}δ^{t)}×e^{-j(}δ⁾=s(t)e^{j(}θ^{t+}β^{t+}δ^{t-}δ⁾=s(t)e^{j(}θ^{t+}β^{t)}=S(t)e^{j(}β^{t)}

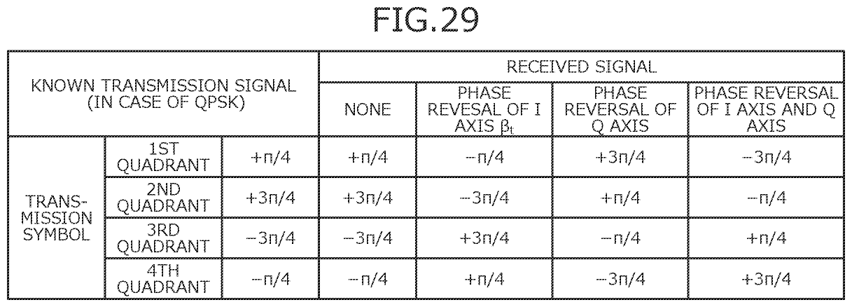

FIG. 29 is a table for explaining operation of the phase reversal compensating unit in operation example 3. The phase reversal compensating unit 103 performs compensation, based on the result of phase reversal detection by the phase reversal detecting unit 105. Here, when performing phase reversal compensation, the phase reversal compensating unit 103 performs I axis phase reversal compensation processing. To perform I axis phase reversal compensation, the phase reversal compensating unit 103 performs processing of interchanging Q axis signs.

Here, the case without noise, etc., is assumed based on the assumption that the transmission signal is a QPSK signal. In such a case, the signal (E(t)′″) input to the phase reversal compensating unit 103 is a signal having I axis phase reversal caused on the transmitting side, since βₜ represents the phase amount by I axis reversal.

The phase reversal compensating unit 103 performs compensation assuming that I axis phase reversal has occurred and hence, the phase reversal compensation is expressed as follows.

E(t)′″×e^{j(-}β^{t)}=S(t)e^{j(}β^{t)}×e^{j(-}β^{t)}=S(t)

As described above, example 3 demonstrates that the phase compensation device 100 may demodulate the received signal correctly.

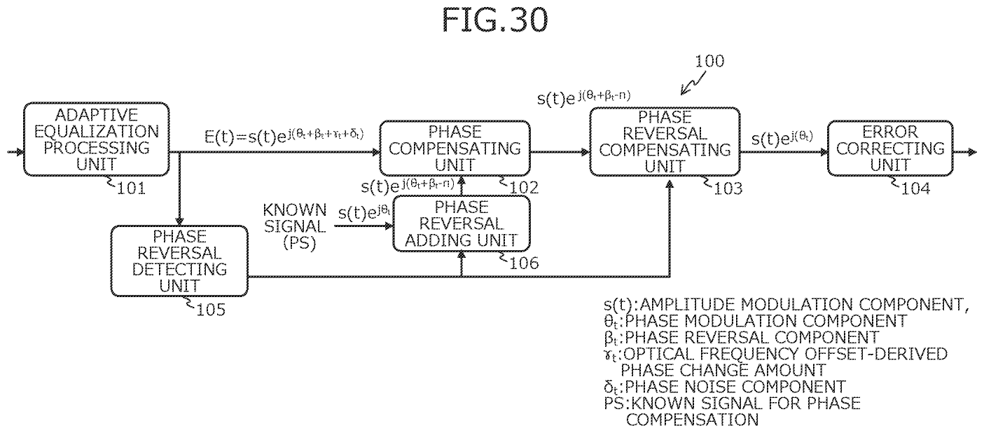

FIG. 30 is a diagram depicting operation example of the phase compensation device in the case where only Q axis phase reversal has occurred.

Description is given assuming a case where only Q axis phase reversal has occurred by the modulator of the optical transmitter 301. In this case, only Q axis phase reversal is occurring and thus, the phase reversal detecting unit 105 decides that phase reversal is occurring. Based on the decision of the phase reversal detecting unit 105 that phase reversal is present, the phase reversal adding unit 106 regards phase reversal as occurring and issues a signal for Q axis phase reversal. The Q axis-only phase reversal may be represented as phase reversal obtained by adding −π as phase to the I axis-only phase reversal (βₜ).

For the signal (E(t)) adaptively equalized by the adaptive equalization processing unit 101, the phase compensating unit 102 estimates the optical frequency offset-derived phase change amount (γₜ) and the phase noise amount (δₜ) by utilizing the output signal of the phase reversal adding unit 106. The phase compensating unit 102 performs phase compensation by utilizing the estimated results.

For the signal after phase compensation by the phase compensating unit 102, the phase reversal compensating unit 103 performs phase reversal compensation based on the result of detection by the phase reversal detecting unit 105. Here, the phase reversal detecting unit 105 detects only whether phase reversal has occurred. As a result, even though Q axis phase reversal has occurred on the transmitting side, the reception side regards the phase reversal as I axis phase reversal and performs phase compensation processing. In this operation example 4, due to the decision that phase reversal is present, the I axis phase reversal (Q axis phase reversal amount −π) is regarded as occurring and compensation is performed.

Here, since the parameter βₜ is the phase reversal amount on the transmitting side, the compensation amount on the reception side is given as follows.

(1) In cases where I axis reversal has occurred on the transmitting side, βₜ is the I axis phase reversal amount. Thus, denotation of the compensation amount on the reception side is as follows:
in case of performing compensation for I axis phase reversal as occurring on the reception side, the compensation amount is denoted by βₜ; and
in case of performing compensation for Q axis phase reversal as occurring on the reception side, the compensation amount is denoted by βₜ−π.
   (2) In cases where Q axis reversal has occurred on the transmitting side, βₜ is the Q axis phase reversal amount. Thus, denotation of the compensation amount on the reception side is as follows:
in case of performing compensation for I axis phase reversal as occurring on the reception side, the compensation amount is denoted by βₜ−π; and
in case of performing compensation for Q axis phase reversal as occurring on the reception side, the compensation amount is denoted by βₜ.

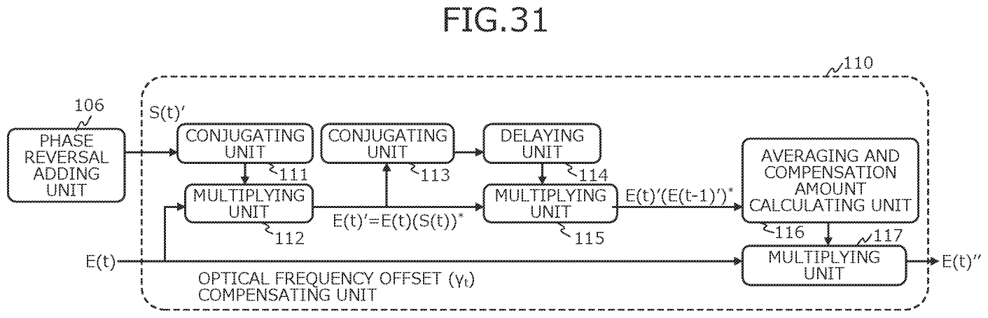

FIG. 31 is a view depicting action of the optical frequency offset compensating unit in operation example 4. The optical frequency offset compensating unit 110 utilizes a pilot of the received signal and a pilot of the transmission signal, to estimate the phase change amount of the optical frequency offset and thereby perform optical frequency offset compensation expressed by the following Formula, using the estimated result.

S(t)′=S(t)e^{j(}β^{t-}π⁾=s(t)e^{j(}θ^{t+}β^{t-}π⁾

E(t)=s(t)e^{j(}θ^{t+}β^{t+}γ^{t+}δ^{t)}

E(t)′=E(t)(S(t)′)*=s(t)e^{j(}θ^{t+}β^{t+}γ^{t+}δ^{t)}(s(t)e^{j(}θ^{t+}β^{t-}π⁾)*=s(t)e^{j(}θ^{t+}β^{t+}γ^{t+}δ^{t)}s(t)e^{-j(}θ^{t+}β^{t-}π⁾=s(t)²e^{j(}γ^{t+}δ^{t+}π⁾

Influence of phase noise may be cancelled (δₜ−δₜ₋ₖ=0) by taking a symbol-to-symbol difference in a short time period (time t and time t−k, k:pilot interval).

E(t)′(E(t−k)′)*=s(t)²e^{j(}γ^{t+}δ^{t+}π⁾s(t−k)²e^{-j(}γ^{t-k+}δ^{t-k+}π⁾=s(t)²s(t−1)²e^{j(}γ^{t-}γ^{t-k+}δ^{t-}δ^{t-k)}

δₜ−δₜ₋ₖ=0 is satisfied and thus, the following is true.

E(t)′(E(t)′)*=s(t)²s(t−1)²e^{j(}γ^{t-}γ^{t-1)}=s(t)²s(t−1)²e^{j}Δγ^{t}

Since Δγₜ, which is the laser frequency difference between transmission and reception, has a small timewise variation, the optical frequency offset compensating unit 110 averages E(t)′(E(t)′)* to reduce noise and then calculates the compensation amount per symbol. In this example, since the variation amount at k symbol is Δγₜ, the change amount per symbol results in Δγₜ/k obtained by multiplying Δγₜ by 1/k. Therefore, the compensation amount per symbol results in −Δγₜ/k=−Δγₜ (k: pilot interval).

The optical frequency offset compensating unit 110 compensates E(t) by utilizing the above value. The optical frequency offset at certain time T can be expressed as follows using phase change amount γ′ of the optical frequency offset at certain timing and Δγ that is the phase variation amount per symbol.

γₜ=γ′+Δγ×t

γ′ is a fixed amount and thus, may be considered as a part of the phase noise component (δₜ). As a result, received data E(t)′ after optical frequency offset compensation may be expressed as follows.

E(t)″=s(t)e^{j(}θ^{t+}β^{t+}Δγ×^{t+}δ^{t)}×e^{j(-}Δγ×^{t)}=s(t)e^{j(}θ^{t+}β^{t+}δ^{t)}

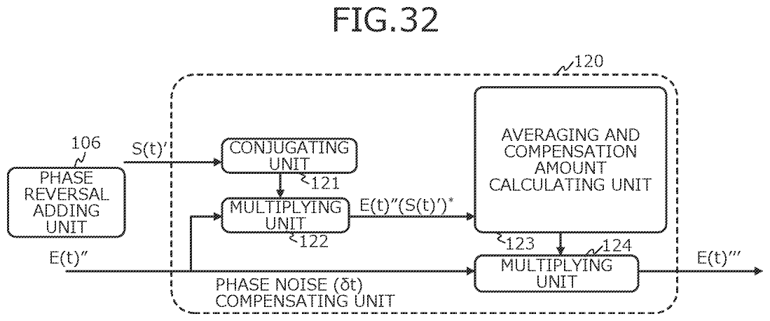

FIG. 32 is a diagram depicting operation of the phase noise compensating unit in operation example 4. For the signal after optical frequency offset compensation, the phase noise compensating unit 120 performs phase noise compensation by using a known transmission signal as a pilot considering phase reversal.

S(t)′=S(t)e^{j(}β^{t-}π⁾=s(t)e^{j(}θ^{t+}β^{t-}π⁾

E(t)″=s(t)e^{j(}θ^{t+}β^{t+}δ^{t)}

E(t)″(S(t)′)*=s(t)e^{j(}θ^{t+}β^{t+}δ^{t)}(s(t)e^{j(}θ^{t+}β^{t-}π⁾)*=s(t)e^{j(}θ^{t+}β^{t+}δ^{t)}s(t)e^{-j(}θ^{t+}β^{t-}π⁾=s(t)²e^{j(}δ⁺π⁾

Phase noise may be regarded as constant (δₜ=δ) in a case of a short time period.

E(t)″(S(t)′)*=s(t)²e^{j(}δ^{t+}π⁾=s(t)²e^{j(}δ⁺π⁾

Since E(t)″(S(t)′)* may be regarded as having a constant phase change amount in case of a short time period, the phase noise compensating unit 120 averages the results of E(t)″(S(t)′)* to reduce noise, to calculate the compensation amount.

The compensation amount by the phase noise compensating unit 120 is a value obtained by multiplying the averaged phase amount by −1. Since the time period to calculate a compensation coefficient and the time period to apply the compensation coefficient are short, a relationship of δₜ=δ is established as follows.

E(t)′″=E(t)′×e^{-j(}δ^{t+}π⁾=s(t)e^{j(}θ^{t+}β^{t+}δ^{t)}×e^{-j(}δ⁺π⁾=s(t)e^{j(}θ^{t+}β^{t+}δ^{t-}δ⁻π⁾=s(t)e^{j(}θ^{t+}β^{t-}π⁾=S(t)e^{j(}β^{t-}π⁾

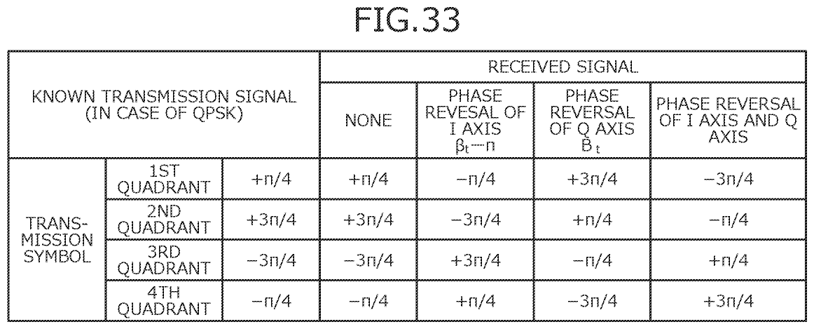

FIG. 33 is a table for explaining operation of the phase reversal compensating unit in operation example 4. The phase reversal compensating unit 103 performs compensation, based on the result of phase reversal detection by the phase reversal detecting unit 105. Here, when performing phase reversal compensation, the phase reversal compensating unit 103 performs phase reversal compensation processing using the Q axis phase reversal amount −π. To perform I axis phase reversal compensation, the phase reversal compensating unit 103 performs processing of interchanging Q axis signs.

Here, the case without noise, etc., is assumed based on the assumption that the transmission signal is a QPSK signal. In such a case, the signal (E(t)′″) input to the phase reversal compensating unit 103 is a signal having I axis phase reversal caused on the transmitting side, since βₜ represents the phase amount by Q axis reversal, βₜ−π represents the phase amount of the I axis reversal.

The phase reversal compensating unit 103 performs compensation assuming that Q axis phase reversal amount −π has occurred and hence, the phase reversal compensation is expressed as follows.

E(t)′″×e^{j(-(}β^{t-}π⁾⁾=S(t)e^{j(}β^{t-}π⁾×e^{j(-(}β^{t-}π⁾⁾=S(t)

As described above, example 4 demonstrates that the phase compensation device 100 may demodulate the received signal correctly.

As in the operation examples 1 to 4 above, in cases where only the I axis phase reversal has occurred by the modulator and in cases where only the Q axis phase reversal has occurred, the phase compensation device 100 performs processing regarding the reception side as having only the I axis phase reversal irrespective of the phase reversal type, to thereby achieve correct demodulation. The phase reversal adding unit 106 and the phase reversal compensating unit 103 perform processing assuming that the same phase reversal has occurred, to thereby enable correct demodulation. Additionally, in cases where only the I axis phase reversal has occurred by the modulator of the optical transmitter 301 and in cases where only the Q axis phase reversal has occurred, the phase compensation device 100 may perform processing assuming that only the Q axis phase reversal has occurred, irrespective of the type of the phase reversal by the modulator, to thereby achieve correct demodulation in the same manner.

The phase compensation device of the embodiment described above compensates phase of a received signal obtained by photoelectrically converting a phase-modulated optical signal. The phase compensation device has: a phase reversal detecting unit that detects presence/absence of phase reversal of the received signal, based on a known signal contained in the received signal; a phase compensating unit that phase-compensates the phase of the received signal, based on the presence/absence of phase reversal detected by the phase reversal detecting unit; and a phase reversal compensating unit that compensates phase reversal of the phase-compensated received signal, based on presence/absence of phase reversal detected by the phase reversal detecting unit. This enables correct phase compensation based on the presence/absence of phase reversal detected by the phase reversal detecting unit, eliminating the need for the conventional N^{th}-power computations, etc., and achieving simplified configuration and reduced power consumption.

The known signal includes a signal for phase reversal detection, and the phase reversal detecting unit detects the presence/absence of phase reversal of the received signal, based on a difference between a phase difference of two symbols as reference of modulation in an optical transmitter, indicated by the signal for phase reversal detection, and a phase difference of two symbols of the received signal. This enables simple detection of the presence/absence of phase reversal using the known signal and received signal between two symbols. Here, the stages upstream to the phase compensating unit are affected by phase fluctuation, i.e., phase fluctuation arising from frequency difference between transmission and reception lasers and phase fluctuation arising from phase noise. However, the phase reversal detecting unit arranged upstream to the phase compensating unit enables phase reversal to be detected correctly without being affected by the phase fluctuation, due to the above configuration.

The phase reversal detecting unit detects, on I and Q axes, two different detection states, i.e., a first detection state where phase reversal is absent or present on both I and Q axes, and a second detection state where phase reversal is present on only the I axis or on only the Q axis, decides the first detection state as without phase reversal and decides the second detection state as with phase reversal, and outputs the result of decision to the phase compensating unit. This reduces the total four different reversal states on I and Q axes into two different reversal results, for output to the phase compensating unit, thus achieving simple phase compensation.

The phase compensation device includes a storage that holds combination patterns of pieces of information concerning phase differences between symbol points in quadrants on the I and Q axes in the state without phase reversal for each time and in the state with phase reversal for each time. The phase reversal detecting unit refers to a phase difference between symbol points corresponding to a combination of two specific symbols of the received signal for each time, from among the combination patterns, to detect the presence/absence of phase reversal, based on whether being located in a region without phase reversal on the I and Q axes or in a region with phase reversal on the I and Q axes. This enables phase reversal of the received signal in each time period to be detected simply, corresponding to different symbol locations on the I and Q axes for each time (for each symbol-to-symbol interval). The storage may store therein in advance information concerning phase of the received signal in each time period indicated by the combination pattern of this known signal.

The phase compensating unit includes: an optical frequency offset compensating unit that compensates an optical frequency offset arising from a laser frequency difference between transmission and reception; and a phase noise compensating unit that compensates a phase difference between transmission and reception. As a result, the optical frequency offset compensating unit and the phase noise compensating unit may correctly compensate the optical frequency offset and the phase noise, respectively, based on the presence/absence of phase reversal detected by the phase reversal detecting unit.

The phase compensating unit includes a phase reversal compensating unit. In cases where the result of the phase reversal detection by the phase reversal detecting unit is a decision of phase reversal being absent, the phase reversal compensating unit outputs the phase-compensated signal as it is. In cases where the result of the phase reversal detection by the phase reversal detecting unit is a decision of phase reversal being present, the phase reversal compensating unit compensates phase reversal, on the basis of the phase amount based on the I axis phase reversal. In cases where the result of the phase reversal detection by the phase reversal detecting unit is a decision of phase reversal being present, the phase reversal compensating unit may compensate phase reversal, on the basis of the phase amount based on the Q axis phase reversal. The case where the result of the phase reversal detection by the phase reversal detecting unit is a decision of phase reversal being absent indicates that phase reversal is absent or that I and Q axes phase reversals are present, whereas the case where the result of the phase reversal detection by the phase reversal detecting unit is a decision of phase reversal being present indicates that only the I axis phase reversal or only the Q axis phase reversal is present. By optimizing the phase reversal output based on the presence/absence of phase reversal in this manner, the phase reversal compensating unit may simply perform the phase compensation.

The optical receiver of the embodiment demodulates the received signal obtained by photoelectrically converting the phase-modulated optical signal. The optical receiver includes: a 90-degree optical hybrid that polarization-separates the received optical signal; a photoelectric converting unit that photoelectrically converts the polarization-separated optical signal; and a demodulating unit that demodulates the photoelectrically converted received signal. The demodulating unit includes: an adaptive equalization processing unit that performs adaptive equalization processing for the received signal; a phase reversal detecting unit that detects the presence/absence of phase reversal of the received signal, based on a known signal contained in the adaptively equalized received signal; a phase compensating unit that phase-compensates phase of the received signal, based on the presence/absence of phase reversal detected by the phase reversal detecting unit; and a phase reversal compensating unit that compensates phase reversal of the phase-compensated received signal, based on the presence/absence of phase reversal detected by the phase reversal detecting unit. This ensures correct detection and compensation on the optical receiver side even though IQ axis phase reversal has occurred in the transmission signal output from the modulator of the optical transmitter.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A phase compensation device configured to compensate phase of a received signal obtained by photoelectrically converting a phase-modulated optical signal, the phase compensation device comprising
a processor configured to:
detect whether reversal of a phase of the received signal is present, based on a known signal contained in the received signal;
compensate the phase of the received signal, based on whether reversal of the phase is detected; and
after compensating the phase, compensate reversal of the phase of the received signal, based on whether reversal of the phase is detected.

2. The phase compensation device according to claim 1, wherein
the known signal includes a signal for detecting reversal of the phase, and
the processor detects whether reversal of the phase of the received signal is present, based on a difference between a phase difference between two symbols as reference of modulation in an optical transmitter, indicated by the signal for detecting reversal of the phase, and a phase difference between two symbols of the received signal.

3. The phase compensation device according to claim 2, wherein
the processor detects, on I and Q axes, two different detection states including a first detection state where reversal of the phase is absent or present on both the I and Q axes, and a second detection state where reversal of the phase is present on only the I axis or only the Q axis, and
the processor, in compensating the phase, decides that reversal of the phase is absent when detecting the first detection state and decides that reversal of the phase is present when detecting the second detection state, and outputs a decision result to compensate the phase.

4. The phase compensation device according to claim 1, wherein
a memory stores therein, as a plurality of known signals that includes the known signal, a plurality of combination patterns of pieces of information concerning phase differences between symbol points in quadrants on I and Q axes for each time, for a state without reversal of the phase and for a state with reversal of the phase, and
the processor, from among the combination patterns, refers to a phase difference between symbol points corresponding to a combination of two specific symbols of the received signal for each time, to detect whether reversal of the phase is present, based on whether being located in a region without reversal of the phase on the I and Q axes or in a region with reversal of the phase on the I and Q axes.

5. The phase compensation device according to claim 1, wherein
the processor further configured to:
compensate an optical frequency offset arising from a laser frequency difference between transmission and reception; and
perform a phase noise compensating process of compensating a phase difference between the transmission and the reception, and
the processor performs compensation based on whether reversal of the phase is detected.

6. The phase compensation device according to claim 1, wherein
the processor:
outputs the received signal as is after compensating the phase, when deciding that reversal of the phase is absent, and
compensates reversal of the phase, on a basis of a phase amount based on I axis phase reversal, when deciding that reversal of the phase is present.

7. The phase compensation device according to claim 6, wherein
an absence of reversal of the phase indicates that reversal of the phase is absent or that I axis and Q axis phase reversals are present, and
a presence of reversal of the phase indicates that only I axis phase reversal or only Q axis phase reversal is present.

8. The phase compensation device according to claim 1, wherein
the processor:
outputs the received signal as is after compensating the phase, when deciding that reversal of the phase is absent, and
compensates reversal of the phase, on a basis of phase amount based on Q axis phase reversal, when deciding that reversal of the phase is present.

9. The phase compensation device according to claim 8, wherein
an absence of reversal of the phase indicates that reversal of the phase is absent or that I axis and Q axis phase reversals are present, and
a presence of the reversal of the phase indicates that only I axis phase reversal or only Q axis phase reversal is present.

10. The phase compensation device according to claim 4, wherein
the combination patterns of the known signal are stored in advance in the storage.

11. An optical receiver configured to demodulate a received signal obtained by photoelectrically converting a phase-modulated optical signal, the optical receiver comprising:
a 90-degree optical hybrid that separates the received optical signal into polarization components;
a photoelectric converting unit that photoelectrically converts the polarization components of the received optical signal; and
a demodulating unit that demodulates the photoelectrically converted polarization components of the received signal,
the demodulating unit having:
an adaptive equalization processing unit that performs adaptive equalization processing for the received signal;
a phase reversal detecting unit that detects a presence or absence of reversal of a phase of the received signal is present, based on a known signal contained in the adaptively equalized received signal;
a phase compensating unit that compensates the phase of the received signal, based on the presence or absence of reversal of the phase detected by the phase reversal detecting unit; and
a phase reversal compensating unit that compensates reversal of the phase of the received signal, based on the presence or absence of reversal of the phase detected by the phase reversal detecting unit.

12. A phase compensation method for compensating a phase of a received signal obtained by photoelectrically converting a phase-modulated optical signal, the method comprising:
detecting a presence or absence of a reversal of the phase of the received signal, based on a known signal contained in the received signal;
compensating the phase of the received signal, based on the detected presence or absence of reversal of the phase; and
after compensating the phase, compensating reversal of the phase of the received signal, based on the detected presence or absence of reversal of the phase.
